(19) United States
(12) Patent Application Publication
(10) Pub. No.: US 2025/0362513 A1
(43) Pub. Date: Nov. 27, 2025

(54) OPTICAL SYSTEM AND PROJECTION IMAGE DISPLAY DEVICE

(71) Applicant: Panasonic Intellectual Property Management Co., Ltd., Osaka (JP)

(72) Inventors: Tsuneo UCHIDA, Chiba (JP); Satoshi KUZUHARA, Osaka (JP); Shunsuke TOMOMATSU, Osaka (JP)

(21) Appl. No.: 19/293,336

(22) Filed: Aug. 7, 2025

Related U.S. Application Data
(63) Continuation of application No. PCT/JP2024/003294, filed on Feb. 1, 2024.

(30) Foreign Application Priority Data
Feb. 10, 2023 (JP) 2023-019004

(51) Int. Cl. G02B 27/01; G02B 27/28

(52) U.S. Cl. CPC G02B 27/0172; G02B 27/283

(57) ABSTRACT

An optical system includes a lens array element including a transmission surface and a first reflecting surface, the transmission surface including a lens array, the first reflecting surface facing the transmission surface, the lens array element being configured to reflect, at the first reflecting surface, light received from the transmission surface and emit the light from the transmission surface; an image display element configured to convert the received light into image light and emit the image light; a plurality of optical elements configured to guide the light emitted from the lens array element to the image display element in a first order; and an opening through which the image light converted at the image display element is emitted. The plurality of optical elements guides the image light emitted from the image display element to the opening in a second order reverse to the first order.

### CROSS REFERENCE TO RELATED APPLICATION

This application claims benefit of priority to International Application No. PCT/JP2024/003294, with an international filing date of Feb. 1, 2024, which claims priority of Japanese Patent Application No. 2023-019004 filed on Feb. 10, 2023, the entire content of which is incorporated herein by reference.

### BACKGROUND ART

### Technical Field

The present disclosure relates to an optical system and a projection image display device.

### Background Art

For example, JP 2000-221499 A discloses a light source used for an image display device. The image display device includes a light modulation unit that reflects emitted light and performs light modulation in accordance with an image signal, and a projection unit that projects reflected light from the light modulation unit.

The light source described in JP 2000-221499 A includes a light emission unit and a polarization conversion unit. The light emission unit emits light with which the light modulation unit is irradiated. The polarization conversion unit is provided on a position just posterior to the light emission unit, and converts a polarization direction of the light so that at least more than 50% of the light emitted from the light emission unit is polarized in a predetermined direction and is emitted.

Further, U.S. Pat. Nos. 9,523,852 and 10,302,957 disclose an optical system using a polarization beam splitter.

### SUMMARY

However, in JP 2000-221499 A, U.S. Pat. Nos. 9,523,852, and 10,302,957, there is still room for improvement in terms of downsizing the optical system.

The present disclosure provides an optical system that achieves downsizing and a projection image display device including the optical system.

An optical system of the present disclosure includes a lens array element including a transmission surface and a first reflecting surface, the transmission surface including a lens array, the first reflecting surface facing the transmission surface, the lens array element being configured to reflect, at the first reflecting surface, light received from the transmission surface and emit the light from the transmission surface, an image display element configured to convert the received light into image light and emit the image light, a plurality of optical elements configured to guide the light emitted from the lens array element to the image display element in a first order, and an opening through which the image light converted at the image display element is emitted. The plurality of optical elements guides the image light emitted from the image display element to the opening in a second order reverse to the first order.

Further, a projection image display device of the present disclosure includes the above-described optical system.

The present disclosure can provide an optical system that achieves downsizing and a projection image display device including the optical system.

### BRIEF DESCRIPTION OF DRAWINGS

FIG. 1A is a schematic side view of a reflective lens array element;

FIG. 1B is a schematic planar view of the reflective lens array element;

FIG. 2 is a schematic view for explaining a concept of an optical system of the present disclosure;

FIG. 3 is a schematic side view for explaining an optical path of the optical system in a first embodiment;

FIG. 4 is a schematic planar view for explaining the optical path of the optical system in the first embodiment;

FIG. 5 is a schematic side view for explaining a polarization state of light of the optical system in the first embodiment;

FIG. 6 is a schematic side view for explaining a configuration example of the optical system in the first embodiment;

FIG. 7 is a schematic side view for explaining an optical path of an optical system in a first modification;

FIG. 8 is a schematic planar view for explaining the optical path of the optical system in the first modification;

FIG. 9 is a schematic side view for explaining an optical path of an optical system in a second embodiment;

FIG. 10 is a schematic planar view for explaining the optical path of the optical system in the second embodiment;

FIG. 11 is a schematic side view for explaining a configuration example of the optical system in the second embodiment;

FIG. 12 is a schematic side view for explaining an optical path of an optical system in a second modification;

FIG. 13A is a schematic diagram for explaining another example of a lens element;

FIG. 13B is a schematic diagram for explaining another example of the lens element;

FIG. 13C is a schematic diagram for explaining another example of the lens element;

FIG. 13D is a schematic diagram for explaining another example of the lens element;

FIG. 13E is a schematic diagram for explaining another example of the lens element;

FIG. 14 is a schematic side view of an optical system according to a third embodiment;

FIG. 15 is a schematic planar view of the optical system according to the third embodiment;

FIG. 16 is a schematic cross-sectional view of the optical system illustrated in FIG. 14 taken along line A-A;

FIG. 17 is a schematic cross-sectional view of the optical system illustrated in FIG. 14 taken along line B-B;

FIG. 18 is a schematic side view of an optical system according to a fourth embodiment;

FIG. 19 is a schematic planar view of the optical system according to the fourth embodiment;

FIG. 20 is a schematic cross-sectional view of the optical system illustrated in FIG. 18 taken along line C-C;

FIG. 21 is a schematic cross-sectional view of the optical system illustrated in FIG. 18 taken along line D-D;

FIG. 22 is a schematic view of an optical system according to a fifth embodiment from a view on a light source side;

FIG. 23 is a schematic view of a first optical system of the optical system according to the fifth embodiment from a view on a reflecting surface side;

FIG. 24 is a schematic cross-sectional view of the optical system illustrated in FIG. 22 taken along line E-E;

FIG. 25 is a schematic cross-sectional view of the optical system illustrated in FIG. 22 taken along line F-F;

FIG. 26 is a schematic view of an optical system according to a third modification from a view on a light source side;

FIG. 27 is a schematic view of the optical system according to the third modification from a view on a reflecting surface of a first optical system;

FIG. 28 is a schematic cross-sectional view of the optical system illustrated in FIG. 26 taken along line G-G;

FIG. 29 is a schematic cross-sectional view of the optical system illustrated in FIG. 26 taken along line H-H;

FIG. 30 is a schematic view for explaining another example of disposing of a light source in the fifth embodiment;

FIG. 31 is a schematic view for explaining another example of the disposing of the light source in the fifth embodiment;

FIG. 32 is a schematic view for explaining another example of the disposing of the light source in the fifth embodiment;

FIG. 33 is a schematic cross-sectional view of an optical system according to a fourth modification;

FIG. 34 is a schematic cross-sectional view of an optical system according to a fifth modification; and

FIG. 35 is a schematic view for explaining a head mount display including the optical system of the fifth embodiment.

### DETAILED DESCRIPTION

### Circumstances to the Present Disclosure

As one aspect of an optical system, an optical system using an image display element is known. Such an optical system includes a projection optical system that projects an image and an illumination optical system that illuminates the image display element. In such an optical system, a lens array element, a lens element, and the like are used in order to make a luminance distribution of light uniform.

However, when the lens array element and the like are used, the size of the optical system tends to be large in order to secure a space for disposing these elements. As the lens array element, a transmissive lens array element is generally used. When the transmissive lens array element is used, a space for securing an optical path of light to be transmitted through the lens element tends to be large.

Further, an illumination optical path from a light source to the image display element and a projection optical path from the image display element to a projection lens are configured in different places. For this reason, downsizing of the optical system is difficult.

Therefore, the present inventors have extensively conducted studies, and have resultantly found a configuration of an optical system using a reflective lens array element, leading to the present disclosure.

### First Embodiment

A first embodiment will be described below with reference to the drawings.

### [1-1. Reflective Lens Array Element]

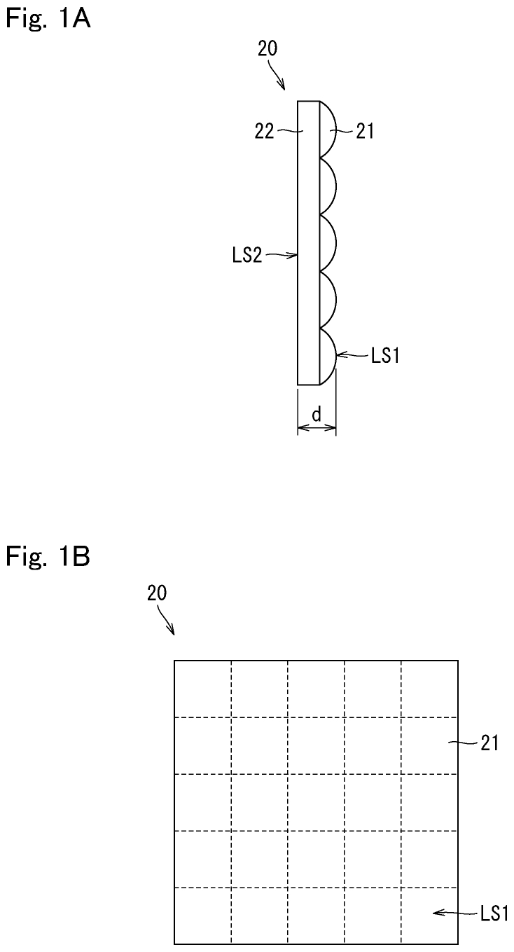

First, a reflective lens array element (hereinafter, referred to as a “lens array element”) will be described with reference to FIGS. 1A and 1B.

FIG. 1A is a schematic side view of a lens array element 20. FIG. 1B is a schematic planar view of the lens array element 20.

As illustrated in FIGS. 1A and 1B, the lens array element 20 includes a first main surface LS1 and a second main surface LS2 located on an opposite side with respect to the first main surface LS1.

A lens array 21 is provided on the first main surface LS1. The lens array 21 is configured by regularly arranging a plurality of lens elements. For example, in the lens array 21, the plurality of lens elements is arranged in a square lattice array. The lens element is, for example, a convex lens. In this specification, the first main surface LS1 may be referred to as a transmission surface.

On the second main surface LS2, a reflecting surface 22 where light is reflected is provided. The reflecting surface 22 may be configured by a flat surface or a curved surface. In this specification, the reflecting surface 22 of the lens array element 20 may be referred to as the “first reflecting surface 22”. Note that the reflecting surface 22 may not be provided on the second main surface LS2. For example, the reflecting surface 22 may be provided between the first main surface LS1 and the second main surface LS2.

The lens array element 20 has, for example, a plate shape.

In the lens array element 20, light enters the first main surface LS1, passes through the lens array 21, and is reflected from the reflecting surface 22 of the second main surface LS2. The light reflected from the second main surface LS2 is emitted from the first main surface LS1.

The thickness of the lens array element 20 can be made smaller than the thickness of the transmissive lens array element. In the transmissive lens array element, the lens array is provided on both a first main surface and a second main surface located on an opposite side with respect to the first main surface. In the transmissive lens array element, light having entered the first main surface is emitted from the second main surface.

The radius of curvature of the lens element is represented by “R” and the refractive index of a material of the lens array element 20 is represented by “N”. In this case, the thickness “d” of the lens array element 20 satisfies the following expression. Alternatively, the thickness “d” desirably falls within a range between 90% and 110% of the right side of the following expression.

$$d = \frac{R \times N}{2 \times ( N - 1 )} \qquad [ Mathematical expression 1 ]$$

For example, the thickness d of the lens array element 20 can be approximately ½ of the thickness of the transmissive lens array element. Therefore, the space for disposing the lens array element 20 can be reduced as compared with the transmissive lens array element.

### [1-2. Concept of Optical System]

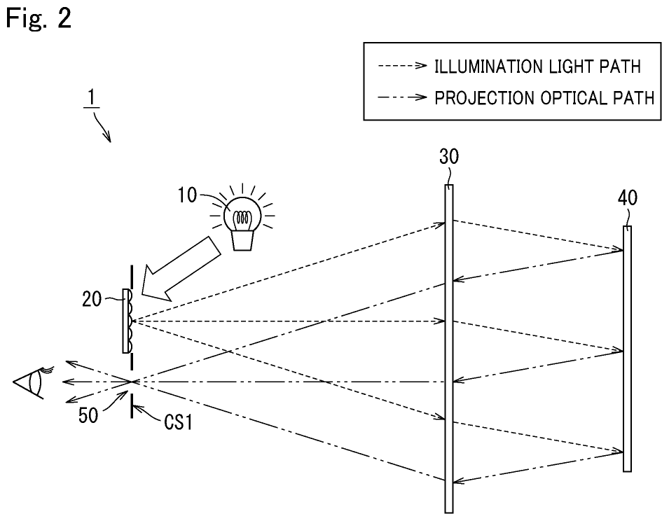

A concept of the optical system using the lens array element in the present disclosure will be described with reference to FIG. 2.

FIG. 2 is a schematic view for explaining the concept of an optical system 1 in the present disclosure.

As illustrated in FIG. 2, the optical system 1 includes a light source 10, a lens array element 20, an optical element 30, an image display element 40, and an opening 50.

In the optical system 1, light emitted from the light source 10 enters the lens array element 20 as illumination light and is reflected, and enters the image display element 40 through the optical element 30. The light having entered the image display element 40 is converted into image light and reflected. The image light then passes through the optical element 30 as projection light to enter the opening 50.

In the optical system 1, the lens array element 20 and the opening 50 are optically conjugate to each other by the optical element 30. Specifically, in the optical system 1, light can travel in opposite directions on the illumination optical path and the projection optical path. The illumination optical path is an optical path where the light emitted from the light source 10 passes through the lens array element 20 and the optical element 30, and enters the image display element 40. The projection optical path is an optical path where the light emitted from the image display element 40 enters the opening 50 through the optical element 30. The optical element 30 includes an optical surface disposed on an optical path from the lens array element 20 to the opening 50. The optical surface has refractive power, and achieves an optical conjugate relationship between the lens array element 20 and the opening 50.

In the optical system 1, since the lens array element 20 and the opening 50 are disposed at different positions on a conjugate surface CS1, commonality can be achieved between the illumination light path and the projection light path. As a result, the optical system 1 can be downsized.

In the optical system 1, the light from the light source 10 is reflected at the lens array element 20. Thus, the light source 10 can be disposed on the first main surface LS1 side of the lens array element 20. That is, the light source 10 is disposed on an opposite side of the conjugate surface CS1 from the side where the lens array element 20 is disposed. Therefore, in the optical system 1, the light source 10 can be disposed closer to the optical element 30 than in an optical system using a transmissive lens array element. As a result, the optical system 1 can be designed compactly. Note that, in the optical system using the transmissive lens array element, light from the light source is transmitted, and thus, the light source is disposed on the same side of the conjugate surface CS1 as the side where the transmissive lens array element is disposed. As a result, since the light source is disposed away from the optical element, the optical system tends to be large.

### [1-3. Configuration of Optical System]

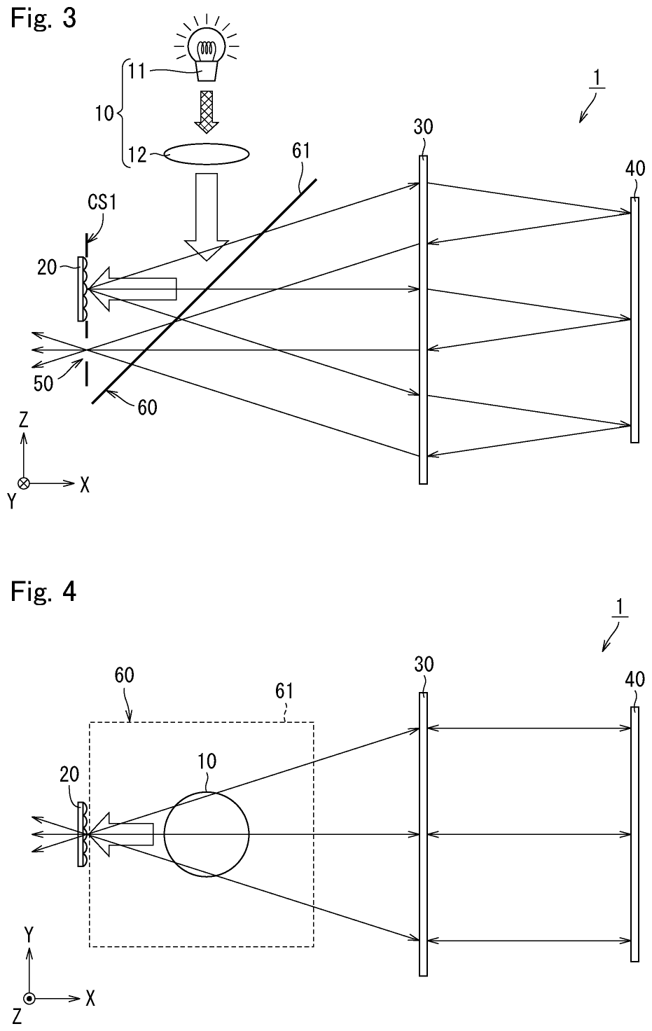

A configuration and an optical path of the optical system 1 achieved based on the above-described concept of the optical system will be described with reference to FIGS. 3 and 4.

FIG. 3 is a schematic side view for explaining the optical path of the optical system 1 in the first embodiment. FIG. 4 is a schematic planar view for explaining the optical path of the optical system 1 in the first embodiment. In FIGS. 3 and 4, X, Y, and Z directions indicate directions orthogonal to each other, and for example, the X direction indicates a width direction, the Y direction indicates a depth direction, and the Z direction indicates a height direction. Arrows illustrated in FIGS. 3 and 4 indicate traveling directions of light beams. The polarization state of light will be described later.

First, the configuration of the optical system 1 will be described. As illustrated in FIGS. 3 and 4, the optical system 1 includes the light source 10, the lens array element 20, the optical element 30, the image display element 40, an opening 50, and a polarization beam splitter 60.

The light source 10 collimates light and emits the collimated light. The light emitted from the light source is, for example, randomly polarized light. For example, the light source 10 changes randomly polarized light having a red (R) light component, a green (G) light component, and a blue (B) light component into approximately parallel light and emits the approximately parallel light.

The light source 10 includes a light source element 11 and a collimator element 12.

The light source element 11 generates light. The light source element 11 is a light emitting diode (LED) or the like, and a plurality of optical elements can be also collectively described as the light source element 11.

The collimator element 12 collimates the light generated at the light source element 11. The collimator element 12 changes the light to approximately parallel light. For example, the collimator element 12 is a collimator lens.

Note that the collimator element 12 may include a plurality of lenses. The collimator element 12 is not limited to the collimator lens. The collimator element 12 may be any optical element that can collimate light. For example, the collimator element 12 may be an optical element such as a mirror or a diffractive optical element.

The polarization beam splitter 60 splits light from the light source 10. Specifically, the polarization beam splitter 60 includes a split surface 61 where first polarized light out of the randomly polarized light is reflected and second polarized light is transmitted.

In the present embodiment, the first polarized light is S-polarized light, and the second polarized light is P-polarized light. The first polarized light and the second polarized light are linearly polarized light.

The lens array element 20 receives and reflects the light passing through the split surface 61. In the present embodiment, the lens array element 20 receives and reflects the light reflected from the split surface 61.

The optical element 30 includes an optical surface disposed on an optical path from the lens array element 20 to the opening 50. The optical surface has refractive power. The optical element 30 includes, for example, a lens element, a reflector element, and the like. In the present embodiment, the optical element 30 constitutes a projection optical system. The optical element 30 guides the light emitted from the lens array element 20 to the image display element 40. Further, the optical element 30 guides the light emitted from the lens array element 20 to the image display element 40 in a predetermined order, and guides the image light emitted from the image display element 40 to the opening 50 in a reverse order of the predetermined order. Note that the polarization beam splitter 60 functions as a part of the optical element that guides light emitted from the lens array element 20 to the image display element 40. For this reason, the polarization beam splitter 60 may be referred to as the optical element.

At the image display element 40, the light reflected from the lens array element 20 is converted into image light, and the image light is emitted. Specifically, at the image display element 40, the incident light tis converted into image light, and the image light is reflected to be emitted.

The image light emitted from the image display element 40 is emitted from the opening 50. The opening 50 is an opening for emitting image light. For example, the opening 50 may be a diaphragm.

In the optical system 1, when viewed from the reflecting surface side of the lens array element 20, that is, when viewed from the width direction (X direction) of the optical system 1, the light source 10, the lens array element 20, and the opening 50 are aligned in the height direction (Z direction) of the optical system 1. Further, when viewed from the light source 10 side, that is, when viewed from the height direction (Z direction) of the optical system 1, the light source 10 is disposed on a projection optical system side including the optical element 30 with respect to the lens array element 20 and the opening 50.

The optical path of the optical system 1 will be described below.

As illustrated in FIGS. 3 and 4, the light source 10 emits light. The light emitted from the light source 10 enters the split surface 61. At the split surface 61, the first polarized light out of the light from the light source 10 is reflected, and the reflected light in a first polarization state is guided to the lens array element 20.

The lens array element 20 receives the light at the first main surface LS1 including the lens array 21, and reflects the light at the second main surface LS2 where the reflecting surface 22 is provided. On the first main surface LS1, the incident light is split into a plurality of secondary light source lights at the lens array 21. The light has passed through the first main surface LS1 is reflected from the second main surface LS2, is emitted from the first main surface LS1, and travels to the split surface 61. At this time, the light in the first polarization state traveling from the lens array element 20 to the split surface 61 is brought into the second polarization state.

The light reflected at the lens array element 20 passes through the split surface 61, and enters the image display element 40 through the projection optical system including the optical element 30. At the image display element 40, the incident light is converted into image light, and the image light is reflected.

The image light reflected at image display element 40 travels to the split surface 61 through the projection optical system including the optical element 30. The image light is transmitted through the split surface 61 and enters the opening 50.

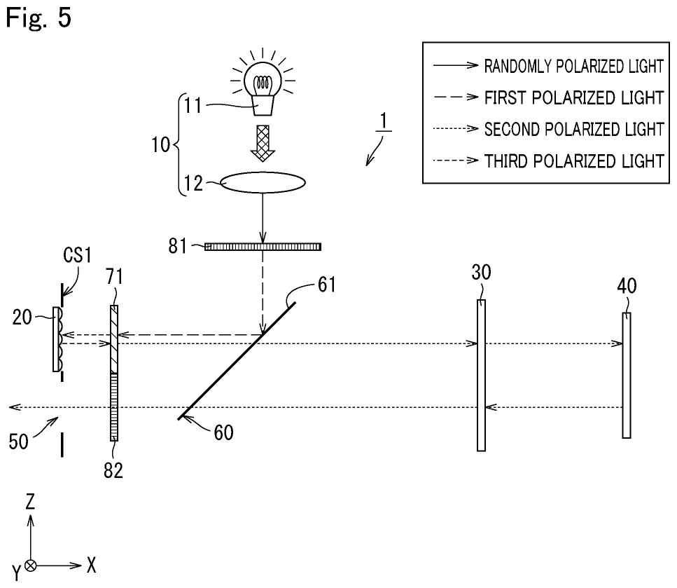

The polarization state of light of the optical system 1 will be described below with reference to FIG. 5.

FIG. 5 is a schematic side view for explaining the polarization state of light of the optical system 1 in the first embodiment.

A configuration for changing the polarization state of light will be described. As illustrated in FIG. 5, the optical system 1 includes a retardation plate 71 that changes the polarization state of light. The optical system 1 further includes a first polarizer 81 and a second polarizer 82 that extract specific light.

The retardation plate 71 is an optical element at which the polarization state is change by giving predetermined retardation to polarized light. The retardation plate 71 is disposed between the split surface 61 of the polarization beam splitter 60 and the lens array element 20.

The retardation plate 71 is a ¼ wave plate. The retardation plate 71 gives retardation of λ/4 to an electric field vibration direction of polarized light.

The retardation plate 71 changes the first polarization state of light to the second polarization state. The light in the first polarization state reflected from the split surface 61 enters the lens array element 20 through the retardation plate 71. The light having entered the lens array element 20 is reflected from the second main surface LS2 having the reflecting surface 22, and enters the split surface 61 through the retardation plate 71. As described above, the light passes through the retardation plate 71 twice in a reciprocating manner, thereby giving retardation of λ/2 to the light. As a result, the first polarization state of the light reflected from the split surface 61 is changed to the second polarization state.

The retardation plate 71 is not limited to the ¼ wave plate. The retardation plate 71 may be any plate for giving retardation in order to change the first polarization state to the second polarization state. For example, the retardation plate 71 may be configured by two ⅛ wave plates, or by four 1/16 wave plates. Further, the retardation plate 71 may give retardation of 0.24×λto 0.26×λ in the electric field vibration direction of the polarized light.

The first polarizer 81 is disposed between the light source 10 and the polarization beam splitter 60, and extracts the first polarized light. Specifically, the first polarizer 81 transmits the first polarized light out of the light emitted from the light source 10 and blocks light other than the first polarized light. In the present embodiment, since the light emitted from the light source 10 is randomly polarized light, the first polarizer 81 extracts the first polarized light from the randomly polarized light.

The second polarizer 82 is disposed between the polarization beam splitter 60 and the opening 50, and extracts the second polarized light. Specifically, the second polarizer 82 transmits the second polarized light out of image light emitted from the image display element 40 and blocks light other than the second polarized light. This reduces unnecessary light.

A change of the polarization state of light in the optical system 1 will be described below.

As illustrated in FIG. 5, the light emitted from the light source 10 enters the split surface 61 through the first polarizer 81. The first polarizer 81 transmits the first polarized light out of the light emitted from the light source 10 and blocks light other than the first polarized light. As a result, the light having passed through the first polarizer 81 is brought into the first polarization state and enters the split surface 61.

At the split surface 61, the light in the first polarization state is reflected and is guided to the lens array element 20. The light reflected from the split surface 61 enters the lens array element 20 through the retardation plate 71. When the light reflected from the split surface 61 passes through the retardation plate 71, retardation of λ/4 is given in the electric field vibration direction of the polarized light. As a result, the light entering the lens array element 20 is brought into a third polarization state. The third polarization state is a state obtained by third polarized light. In the present embodiment, the third polarized light is circularly polarized light or elliptically polarized light.

In the lens array element 20, light passes through the first main surface LS1 and is reflected from the second main surface LS2. The reflected light enters the split surface 61 through the first main surface LS1 and the retardation plate 71. The light reflected at the lens array element 20 passes through the retardation plate 71, and thus retardation of λ/4 is given again in the electric field vibration direction of the polarized light. As a result, the third polarization state of the light is changed to the second polarization state.

The light brought into the second polarization state passes through the split surface 61, and enters the image display element 40 through the projection optical system including the optical element 30. At the image display element 40, the light is converted into image light, and the image light is reflected.

The image light reflected at the image display element 40 enters the split surface 61 through the projection optical system. Since the image light is in the second polarization state, the image light is transmitted through the split surface 61. The image light transmitted through the split surface 61 is emitted from the opening 50 through the second polarizer 82. The second polarizer 82 transmits the second polarized light out of the image light and blocks light other than the second polarized light. This reduces unnecessary light.

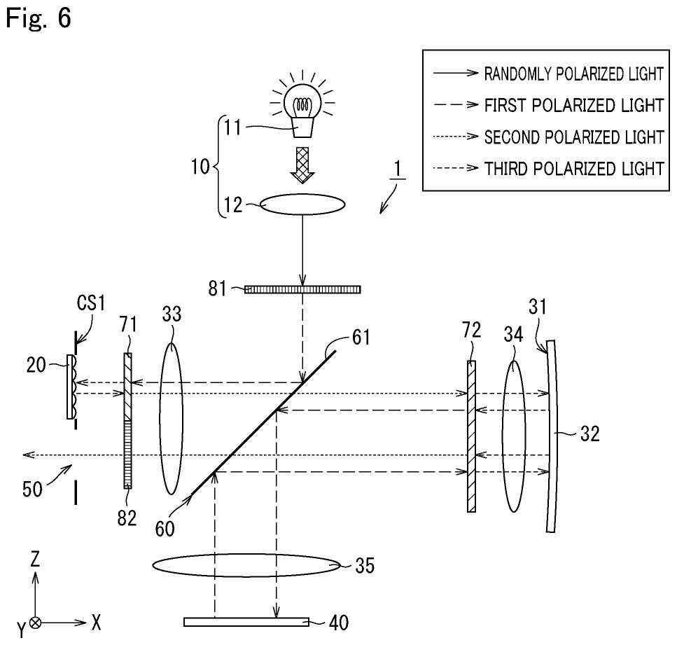

An example of the configuration of the optical system 1 will be described below with reference to FIG. 6.

FIG. 6 is a schematic side view for explaining the configuration example of the optical system 1 in the first embodiment. FIG. 6 illustrates an example where the projection optical system includes a reflector element 32 having a reflecting surface 31 and first to third lens elements 33 to 35, that is, an example where the optical surface includes the reflecting surface 31 and the first to third lens elements 33 to 35.

As illustrated in FIG. 6, the optical system 1 includes, as the optical element 30, the reflector element 32 including the reflecting surface 31, the first lens element 33, the second lens element 34, and the third lens element 35. The optical system 1 further includes a second retardation plate 72 in addition to the first retardation plate 71.

The reflector element 32 is an optical element at which light is reflected. The reflector element 32 includes the reflecting surface 31 from which light is reflected. The reflector element 32 is disposed on the side opposite from the lens array element 20 and the opening 50 with the split surface 61 being interposed between the reflector element 32 and these components, and is disposed on an optical path where light reflected at the lens array element 20 travels through the split surface 61. In this specification, the reflecting surface 31 of the reflector element 32 may be referred to as a “second reflecting surface 31”.

At the reflecting surface 31, the light reflected at the lens array element 20 and transmitted through the split surface 61 of the polarization beam splitter 60 is reflected, and guided to the split surface 61.

The reflecting surface 31 is configured by, for example, a curved surface. The reflecting surface 31 may be configured by a flat surface.

For example, as the reflector element 32, a mirror or a lens having a curved surface can be used.

The first lens element 33 is disposed between the split surface 61 of the polarization beam splitter 60 and the lens array element 20. That is, the first lens element 33 is disposed on an optical path where light travels between the split surface 61 and the lens array element 20.

The second lens element 34 is disposed between the split surface 61 of the polarization beam splitter 60 and the reflecting surface 31 of the reflector element 32. That is, the second lens element 34 is disposed on an optical path where light travels between the split surface 61 and the reflecting surface 31. The reflecting surface 31 may be formed on the optical surface of second lens element 34. In this case, the cost can be reduced by omitting a holding member of the reflector element, and the size can be reduced by the thickness of the omitted holding member.

The third lens element 35 is disposed between the split surface 61 of the polarization beam splitter 60 and the image display element 40. That is, the third lens element 35 is disposed on an optical path where light travels between the split surface 61 and the image display element 40.

The first lens element 33 to third lens element 35 are lenses configured to condense light. The first lens element 33 to third lens element 35 also serve as relay lenses, for example.

The first retardation plate 71 is similar to the retardation plate 70 illustrated in FIG. 5.

The second retardation plate 72 is disposed between the split surface 61 of the polarization beam splitter 60 and the reflecting surface 31 of the reflector element 32. The second retardation plate 72 has the configuration similar to that of the first retardation plate 71. Note that the second retardation plate 72 may have a configuration different from that of the first retardation plate 71.

The optical path from the light source 10 to the opening 50 and the polarization state in the optical system 1 will be described below.

As illustrated in FIG. 6, the light emitted from the light source 10 enters the split surface 61 through the first polarizer 81. The light having passed through the first polarizer 81 is brought into the first polarization state and enters the split surface 61.

At the split surface 61, the light in the first polarization state is reflected and is guided to the lens array element 20. The light reflected from the split surface 61 enters the lens array element 20 through the first lens element 33 and the first retardation plate 71. The light having passed through the first retardation plate 71 in the first polarization state is brought into the third polarization state, and enters the lens array element 20. In a case where the first lens element 33 is disposed, the light from the light source 11 having passed through the first lens element 33 is desirably brought into an approximately collimated state due to optical actions of the collimator element 12 and the first lens element 33, and enters the lens array element 20.

In the lens array element 20, light passes through the first main surface LS1 and is reflected from the second main surface LS2. The reflected light passes through the first main surface LS1, and enters the split surface 61 through the first retardation plate 71 and the first lens element 33. The light in the third polarization state having passed through the first retardation plate 71 is brought into the second polarization state, and enters the split surface 61. The light having passed through first lens element 33 is guided toward the split surface 61 by the optical action of the first lens element 33.

The light brought into the second polarization state is transmitted through the split surface 61, and enters the reflector element 32 through the second retardation plate 72 and the second lens element 34. The light in the second polarization state having passed through the second retardation plate 72 is brought into the third polarization state, and is guided toward the reflecting surface 31 of the reflector element 32 by an optical action of the second lens element 34. The light having entered the reflector element 32 is reflected from the reflecting surface 31.

The light reflected from the reflecting surface 31 enters the split surface 61 through the second lens element 34 and the second retardation plate 72. The light having passed through the second lens element 34 is condensed toward the split surface 61, and passes through the second retardation plate 72. As a result, the light in the third polarization state is brought into the first polarization state.

At the split surface 61, the light in the first polarization state is reflected and is guided to the image display element 40. The light reflected from the split surface 61 enters the image display element 40 through the third lens element 35. The light having passed through the third lens element 35 is guided toward the image display element 40. When the first main surface LS1 of the lens array element 20 is considered as the secondary light source, the light beam directing toward the image display element 40 passes through the first lens element 33, the second lens element 34, the reflector element 32, the second lens element 34, and the third lens element 35 in this order along the traveling direction of the light beam. The light beam directing toward the image display element 40 is then guided to the image display element 40 in an approximately collimated state by optical actions of the respective lens elements through which the light beam has passed. At the image display element 40, the light is converted into image light, and the image light is reflected.

The image light reflected at the image display element 40 enters the split surface 61 through the third lens element 35. The image light having passed through the third lens element 35 is guided toward the split surface 61. Since the image light is in the first polarization state, the image light is reflected from the split surface 61 and guided to the reflector element 32.

The image light reflected from the split surface 61 enters the reflecting surface 31 of the reflector element 32 through the second retardation plate 72 and the second lens element 34. The image light in the first polarization state having passed through the second retardation plate 72 is brought into the third polarization state, and is guided toward the reflecting surface 31 at the second lens element 34. At the reflecting surface 31, the image light is reflected and is guided to the split surface 61.

The image light reflected from the reflecting surface 31 enters the split surface 61 through the second lens element 34 and the second retardation plate 72. The image light having passed through the second lens element 34 is guided toward the split surface 61, and the image light in the third polarization state is brought into the second polarization state at the second retardation plate 72.

The image light in the second polarization state is transmitted through the split surface 61 and is guided to the opening 50. The image light transmitted through the split surface 61 enters the opening 50 through the first lens element 33 and the second polarizer 82. The image light having passed through the first lens element 33 is guided toward the opening 50. The second polarized light is extracted from the image light by the second polarizer 82 and enters the opening 50.

At the plurality of optical elements 30 and the polarization beam splitter 60, the light emitted from the lens array element 20 passes through the first lens element 33, the split surface 61 of the polarization beam splitter 60, the second lens element 34, the reflecting surface 31 of the reflector element 32, the second lens element 34, the split surface 61 of the polarization beam splitter 60, and the third lens element 35 to be guided to the image display element 40 in a first order. At the plurality of optical elements 30 and the polarization beam splitter 60, the light passes through the third lens element 35, the split surface 61 of the polarization beam splitter 60, the second lens element 34, the reflecting surface 31 of the reflector element 32, the second lens element 34, the split surface 61 of the polarization beam splitter 60, and the first lens element 33 to be guided to the opening 50 in a second order. As described above, the plurality of optical elements 30 and the polarization beam splitter 60 are configured so that the first order of guiding the light emitted from the lens array element 20 to the image display element 40 is reverse to the second order of guiding the image light emitted from the image display element 40.

### [2. Effects, etc.]

As described above, the optical system 1 includes the lens array element 20, the image display element 40, the plurality of optical elements 30 and 60, and the opening 50. The lens array element 20 includes the transmission surface where the lens array 21 is provided and the reflecting surface 22 facing the transmission surface. At the lens array element 20, the light received from the transmission surface is reflected at the reflecting surface 22, and the light is emitted from the transmission surface. At the image display element 40, the received light is converted into image light, and the image light is emitted. At the plurality of optical elements 30 and 60, the light emitted from the lens array element 20 is guided to the image display element 40 in the first order. The image light converted at the image display element 40 is emitted from the opening 50. Further, at the plurality of optical elements 30 and 60, the image light emitted from the image display element 40 is guided to the opening 50 in the second order reverse to the first order.

With such a configuration, downsizing of the optical system 1 can be achieved. In general, a transmissive lens array element, a lens element, or the like is used to make the luminance distribution of light uniform. In the optical system 1, the number of optical components such as the number of lens elements can be reduced by using the reflective lens array element 20. In addition, the lens array element 20 is thinner than a generally used transmissive lens array element, and a disposing space for this element can be small. The flexibility for disposing the optical components can be improved. In the optical system 1, the plurality of optical elements 30 and 60 is configured so that the first order of guiding light from the lens array element 20 to the image display element 40 is reverse to the second order of guiding light from the image display element 40 to the opening 50. As a result, a compact optical system can be achieved while the number of the optical elements 30 is reduced.

The lens array element 20 and the opening 50 are optically conjugate to each other by the optical element 30. With such a configuration, the optical system 1 can be downsized. Specifically, in the optical system 1, since the lens array element 20 and the opening 50 are optical conjugate to each other, light can travel in opposite directions on the illumination light path from the light source 10 to the image display element 40 and on the projection light path from the image display element 40 to the opening 50. That is, commonality can be achieved between the illumination optical path and the projection optical path. As a result, the optical system 1 can be further downsized.

The plurality of optical elements 30 and 60 each includes the split surface 61 where light is split. At the split surface 61, the first polarized light is reflected and the second polarized light is transmitted. At the lens array element 20, the light in the first polarization state reflected from the split surface 61 is received and reflected. With such a configuration, the first polarized light out of the light is reflected from the split surface 61, and the light in the first polarization state can be guided to the lens array element 20. As a result, the optical system 1 can be further downsized.

The optical system 1 includes the retardation plates 71 and 72 at which the polarization state of light is changed. With such a configuration, the polarization state of light can be changed. Further, by changing the polarization state of the light, light reflected from the split surface 61 and the light transmitted therethrough can be selectively used.

The retardation plates 71 and 72 are ¼ wave plates. With such a configuration, since the polarization state of light can be changed with a simpler configuration, the optical system 1 can be further downsized.

The plurality of optical elements 30 and 60 each includes the reflecting surface 31 where light reflected at the lens array element 20, and transmitted through the split surface 61 to be received is reflected. The retardation plates 71 and 72 each include the first retardation plate 71 disposed between the lens array element 20 and the split surface 61, and the second retardation plate 72 disposed between the split surface 61 and the reflecting surface 31. With such a configuration, the optical system 1 can be further downsized by combining the reflection of light and the change of the polarization state.

The optical system 1 includes the light source 10 that emits light. At the split surface 61, the light in the first polarization state out of the light emitted from the light source 10 is reflected, and is guide to the lens array element 20 through the first retardation plate 71. At the lens array element 20, the light is reflected to be guided to the split surface 61 through the first retardation plate 71. The light passes through the first retardation plate 71 in a reciprocating manner, and thus the polarization state of the light is changed from the first polarization state to the second polarization state. The light brought into the second polarization state at the first retardation plate 71 is transmitted through the split surface 61, thereby guiding the light to the second reflecting surface 31 through the second retardation plate 72. The light is reflected from the second reflecting surface 31 to be guided to the split surface 61 through the second retardation plate 72. The light passes through the second retardation plate 72 in a reciprocating manner, and thereby changing the polarization state of the light from the second polarization state to the first polarization state. The light brought into the first polarization state at the second retardation plate 72 is reflected from the split surface 61 to be guided to the image display element 40. At the image display element 40, the light is converted into image light, and the image light is guided to the split surface 61. The image light is reflected from the split surface 61 to be guided to the second reflecting surface 31 through the second retardation plate 72. The image light is reflected from the second reflecting surface 31 to be guided to the split surface 61 through the second retardation plate 72. The image light passes through the second retardation plate 72 in a reciprocating manner, thereby changing the polarization state of the image light from the first polarization state to the second polarization state. The image light brought into the second polarization state at the second retardation plate 72 is transmitted through the split surface 61 to be guided to the opening 50. With such a configuration, the optical system 1 can be downsized.

The plurality of optical elements 30 and 60 each includes the lens element. For example, the lens element includes the first lens element 33, the second lens element 34, and the third lens element 35. The first lens element 33 is disposed between the split surface 61 and the lens array element 20. The second lens element 34 is disposed between the split surface 61 and the reflecting surface 31. The third lens element 35 is disposed between the split surface 61 and the image display element 40. With such a configuration, the luminance distribution of light can be made uniform.

The optical system 1 includes the first polarizer 81 that is disposed between the split surface 61 and the light source 10 and extracts first polarized light. The optical system 1 further includes the second polarizer 82 that is disposed between the split surface 61 and the opening 50 and extracts second polarized light. With such a configuration, unnecessary light can be reduced.

Note that, in the present embodiment, an example has been described in which the light source 10, the lens array element 20, and the opening 50 are aligned in the height direction (Z direction) of the optical system 1 when viewed from the reflecting surface side (X direction) of the lens array element 20, but the present disclosure is not limited thereto.

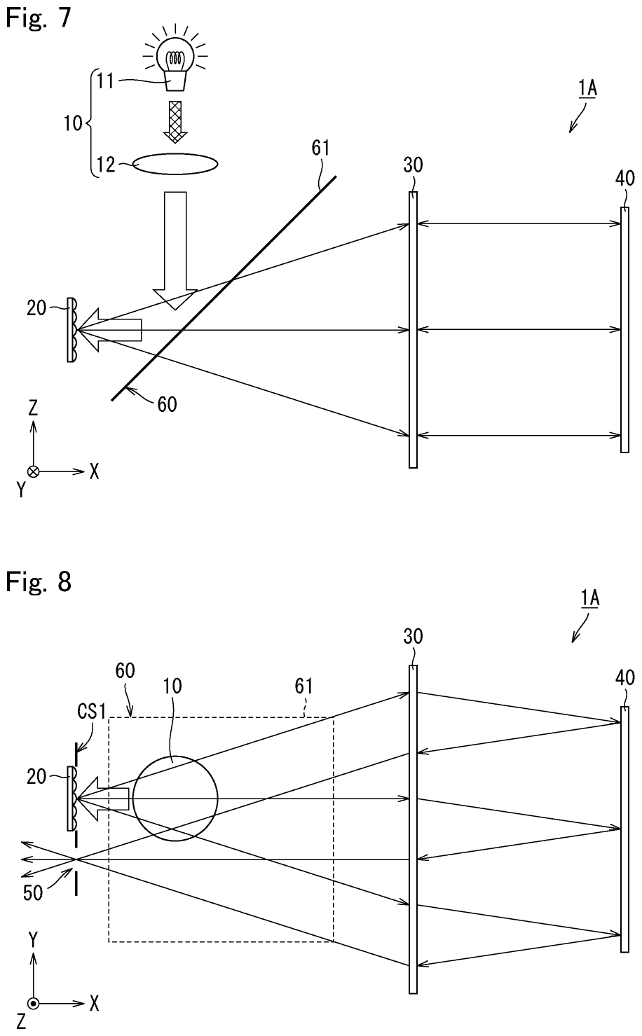

FIG. 7 is a schematic side view for explaining an optical path of an optical system 1A in a first modification. FIG. 8 is a schematic planar view for explaining the optical path of the optical system 1A in the first modification. As illustrated in FIGS. 7 and 8, in the optical system 1A, when viewed from the reflecting surface side of the lens array element 20, that is, when viewed from the width direction (X direction) of the optical system 1A, the light source 10 and the lens array element 20 may be aligned in the height direction (Z direction) of the optical system 1A. Further, when viewed from the light source 10 side, that is, when viewed from the height direction (Z direction) of the optical system 1A, the lens array element 20 and the opening 50 may be disposed side by side in the depth direction (Y direction) of the optical system 1A.

As described above, in the optical system 1A, the light source 10, the lens array element 20, and the opening 50 may be disposed side by side in an L shape when viewed from the height direction (Z direction) of the optical system 1A. Even in such a configuration of the optical system 1A, the effects similar to those of the optical system 1 can be produced.

### Second Embodiment

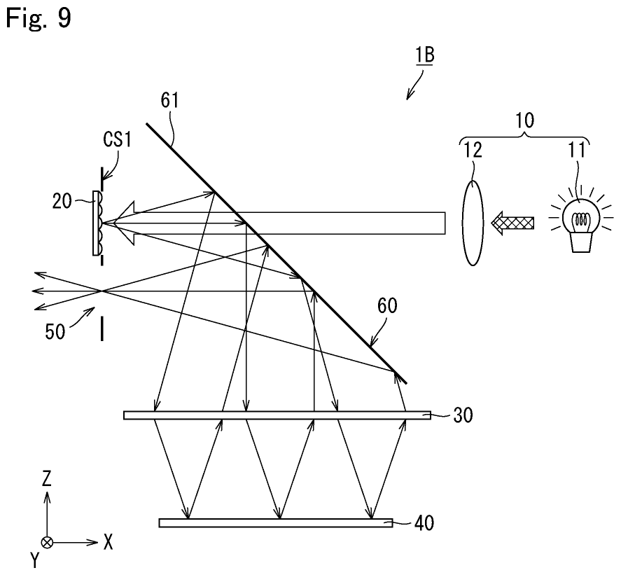

An optical system 1B according to a second embodiment will be described with reference to FIG. 9. FIG. 9 is a schematic side view for explaining an optical path of the optical system 1B in the second embodiment. Arrows illustrated in FIG. 9 indicate traveling directions of light beams. The polarization state of light will be described later.

In the optical system 1B according to the second embodiment, light emitted from a light source 10 passes through a split surface 61 to enter a lens array element 20. The light reflected at the lens array element 20 is reflected from the split surface 61, and enters an image display element 40 through an optical element 30. The image light reflected at the image display element 40 passes through the optical element 30, and is reflected from split surface 61 to enter the opening 50. The points of the configuration other than the above-described points and points described below are common between the optical system 1B according to the second embodiment and the optical system 1 according to the first embodiment.

As illustrated in FIG. 9, in the optical system 1B, the light source 10 emits light. The light emitted from the light source 10 enters the split surface 61. First polarized light out of the light from the light source 10 is reflected from the split surface 61, and second polarized light is transmitted therethrough. At the split surface 61, the transmitted light in the second polarization state is guided to the lens array element 20.

At the lens array element 20, the light is received at a first main surface LS1 including a lens array 21, and reflected from a second main surface LS2 including a reflecting surface 22 to be guided from the first main surface LS1 to the split surface 61. At this time, the light traveling from the lens array element 20 to the split surface 61 is brought into the first polarization state.

The light reflected at the lens array element 20 is reflected from the split surface 61, and enters the image display element 40 through a projection optical system including the optical element 30. At the image display element 40, the incident light is converted into image light, and the image light is reflected.

The image light reflected at image display element 40 travels to the split surface 61 through the projection optical system including the optical element 30. The image light is reflected from the split surface 61 and enters the opening 50.

In the optical system 1B, when viewed from the reflecting surface side of the lens array element 20, that is, when viewed from the width direction (X direction) of the optical system 1B, the lens array element 20, the image display element 40, and the opening 50 are aligned in the height direction (Z direction) of the optical system 1B. On the other hand, the light source 10 and the lens array element 20 overlap each other in the width direction (X direction) of the optical system 1B.

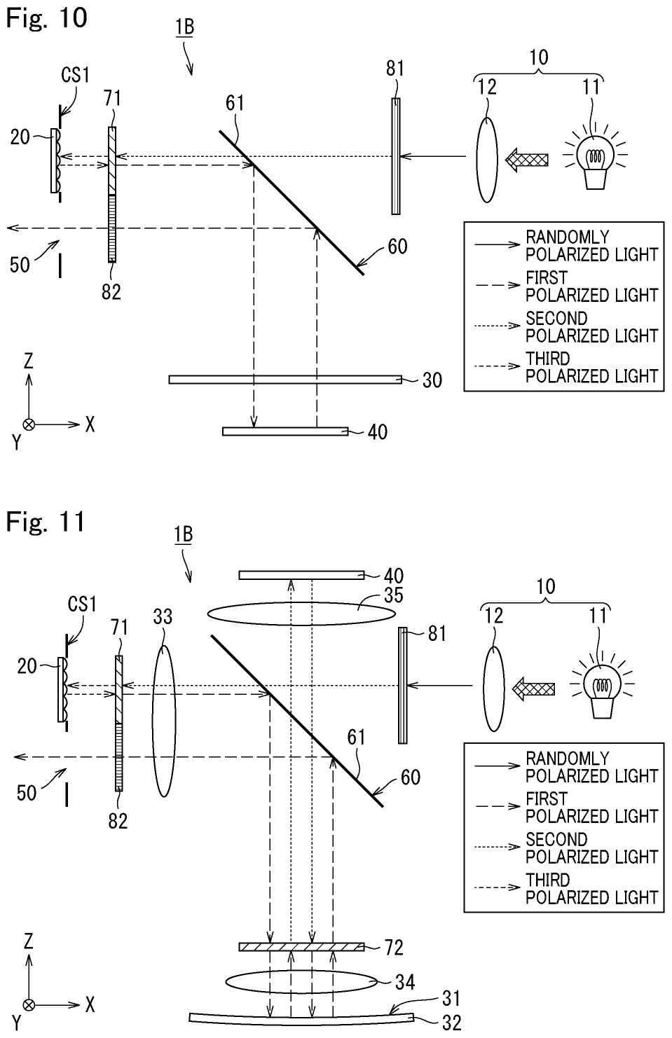

The polarization state of light in the optical system 1B will be described below with reference to FIG. 10.

FIG. 10 is a schematic planar view for explaining an optical path of the optical system 1B in the second embodiment.

As illustrated in FIG. 10, the light emitted from the light source 10 enters the split surface 61 through the first polarizer 81. The first polarizer 81 transmits the second polarized light out of the light emitted from the light source 10 and blocks light other than the second polarized light. As a result, the light passing through the first polarizer 81 is brought into the second polarization state and enters the split surface 61.

The light in the second polarization state is transmitted through the split surface 61 and is guided to the lens array element 20. The light transmitted through the split surface 61 enters the lens array element 20 through a retardation plate 71. The light in the second polarization state transmitted through the split surface 61 passes through the first retardation plate 71 to be brought into the third polarization state. As a result, the light entering the lens array element 20 is brought into a third polarization state.

In the lens array element 20, light passes through the first main surface LS1 and is reflected from the second main surface LS2. The reflected light enters the split surface 61 through the first main surface LS1 and the retardation plate 71. The light in the third polarization state reflected at the lens array element 20 passes through the retardation plate 71 to be brought into the first polarization state.

The light brought into the first polarization state is reflected from the split surface 61, and enters the image display element 40 through the projection optical system including the optical element 30. At the image display element 40, the light is converted into image light, and the image light is reflected.

The image light reflected at the image display element 40 enters the split surface 61 through the projection optical system. Since the image light is in the first polarization state, the image light is reflected from the split surface 61. The image light reflected from the split surface 61 is emitted from the opening 50 through a second polarizer 82. The second polarizer 82 transmits the first polarized light out of the image light and blocks light other than the first polarized light. This can reduce unnecessary light.

An example of the configuration of the optical system 1B will be described below with reference to FIG. 11.

FIG. 11 is a schematic side view for explaining a configuration example of the optical system 1B in the second embodiment. FIG. 11 illustrates an example where the projection optical system is configured by a reflector element 32 having a reflecting surface 31 and lens elements 33 to 35, that is, an example where the optical surface is configured by the reflecting surface 31 and the lens elements 33 to 35.

As illustrated in FIG. 11, the light emitted from the light source 10 enters the split surface 61 through the first polarizer 81. The light having passed through the first polarizer 81 is brought into the second polarization state and enters the split surface 61. The light in the second polarization state is transmitted through the split surface 61 and is guided to the lens array element 20. The light transmitted through the split surface 61 enters the lens array element 20 through the first lens element 33 and the first retardation plate 71. The light in the second polarization state having passed through the first retardation plate 71 is brought into the third polarization state, and enters the lens array element 20. The light having passed through the first lens element 33 is guided toward the lens array element 20.

In the lens array element 20, light passes through the first main surface LS1 and is reflected from the second main surface LS2. The reflected light passes through the first main surface LS1, and enters the split surface 61 through the first retardation plate 71 and the first lens element 33. The light in the third polarization state having passed through the first retardation plate 71 is brought into the first polarization state, and enters the split surface 61. The light having passed through the first lens element 33 is guided toward the split surface 61.

The light brought into the first polarization state is reflected from the split surface 61, and enters the reflector element 32 through the second retardation plate 72 and the second lens element 34. The light in the first polarization state having passed through the second retardation plate 72 is brought into the third polarization state, and is guided toward the reflecting surface 31 of the reflector element 32 by the second lens element 34. The light having entered the reflector element 32 is reflected from the reflecting surface 31.

The light reflected from the reflecting surface 31 enters the split surface 61 through the second lens element 34 and the second retardation plate 72. The light having passed through the second lens element 34 is guided toward the split surface 61, and passes through the second retardation plate 72. As a result, the light in the third polarization state is brought into the second polarization state.

The light in the second polarization state is transmitted through the split surface 61, and is guided to the image display element 40. The light transmitted through the split surface 61 enters the image display element 40 through the third lens element 35. The light having passed through the third lens element 35 is guided toward the image display element 40. At the image display element 40, the light is converted into image light, and the image light is reflected.

The image light reflected at the image display element 40 enters the split surface 61 through the third lens element 35. The image light having passed through the third lens element 35 is guided toward the split surface 61. Since the image light is in the second polarization state, the image light is transmitted through the split surface 61 and guided to the reflector element 32.

The image light transmitted through the split surface 61 enters the reflecting surface 31 of the reflector element 32 through the second retardation plate 72 and the second lens element 34. The image light in the second polarization state having passed through the second retardation plate 72 is brought into the third polarization state, and is guided toward the reflecting surface 31 by the second lens element 34. At the reflecting surface 31, the image light is reflected and is guided to the split surface 61.

The image light reflected from the reflecting surface 31 enters the split surface 61 through the second lens element 34 and the second retardation plate 72. The image light having passed through the second lens element 34 is guided toward the split surface 61, and the image light in the third polarization state is brought into the first polarization state by the second retardation plate 72.

The image light in the first polarization state is reflected from the split surface 61 and is guided to the opening 50. The image light reflected from the split surface 61 enters the opening 50 through the first lens element 33 and the second polarizer 82. The image light having passed through the first lens element 33 is guided toward the opening 50. The first polarized light is extracted from the image light by the second polarizer 82 and enters the opening 50. This can reduce unnecessary light.

Also in the optical system 1B, as in the optical system 1, the plurality of optical elements 30 and a polarization beam splitter 60 are configured so that a first order of guiding the light emitted from the lens array element 20 to the image display element 40 is reversed relative to a second order of guiding the image light emitted from the image display element 40.

In such a way, in the optical system 1B, the light in the second polarization state out of the light emitted from the light source 10 is transmitted through the split surface 61, and is guided to the lens array element 20 through the first retardation plate 71. At the lens array element 20, the light is reflected to be guided to the split surface 61 through the first retardation plate 71. The light passes through the first retardation plate 71 in a reciprocating manner, thereby changing the polarization state of the light from the second polarization state to the first polarization state. The light brought into the first polarization state at the first retardation plate 71 is reflected from the split surface 61, thereby guiding the light to the second reflecting surface 31 through the second retardation plate 72. The light is reflected from the second reflecting surface 31 to be guided to the split surface 61 through the second retardation plate 72. The light passes through the second retardation plate 72 in a reciprocating manner, thereby changing the polarization state of the light from the first polarization state to the second polarization state. The light brought into the second polarization state at the second retardation plate 72 is transmitted through the split surface 61 to be guided to the image display element 40. At the image display element 40, the light is converted into image light, and the image light is guided to the split surface 61. The image light is transmitted through the split surface 61 to be guided to the second reflecting surface 31 through the second retardation plate 72. The image light is reflected from the second reflecting surface 31 to be guided to the split surface 61 through the second retardation plate 72. The image light passes through the second retardation plate 72, thereby changing the polarization state of the image light from the second polarization state to the first polarization state. The image light brought into the first polarization state at the second retardation plate 72 is reflected from the split surface 61 to be guided to the opening 50.

With such a configuration, the optical system 1B can be downsized. The flexibility for disposing the optical components can be improved.

Note that, in the present embodiment, an example has been described in which the lens array element 20, the image display element 40, and the opening 50 are aligned in the height direction (Z direction) of the optical system 1B when viewed from the reflecting surface side (X direction) of the lens array element 20, but the present disclosure is not limited thereto.

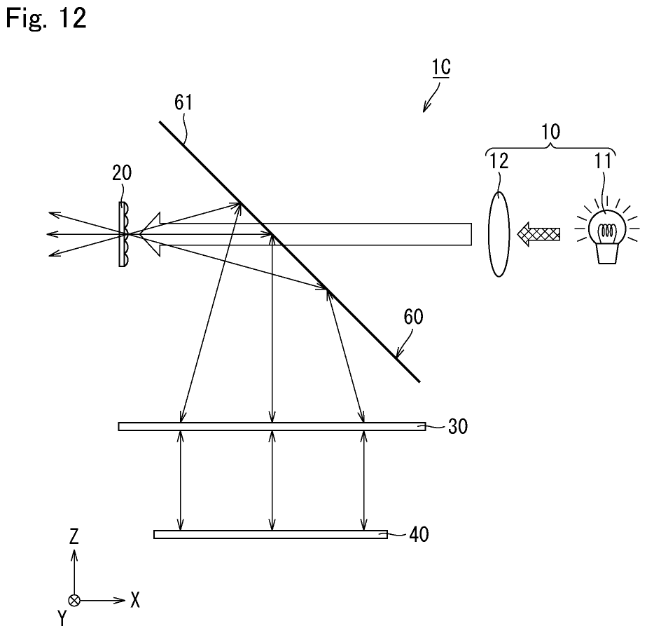

FIG. 12 is a schematic side view for explaining an optical path of an optical system 1C in a second modification. As illustrated in FIG. 12, in the optical system 1C, when viewed from the reflecting surface side of the lens array element 20, that is, when viewed from the width direction (X direction) of the optical system 1C, the lens array element 20, the image display element 40, and the opening 50 are disposed into an L shape. Even in such a configuration of the optical system 1C, the effects similar to those of the optical system 1B can be obtained.

Further, in the optical system 1B, the position, shape, and number of the first lens elements 33 are not limited to those in the present embodiment.

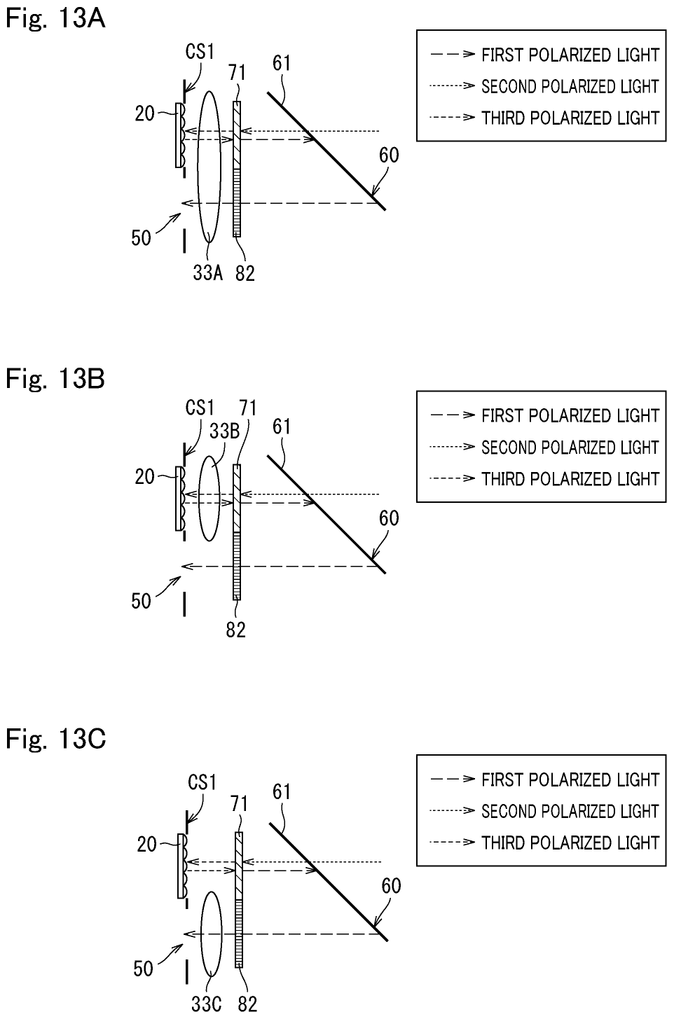

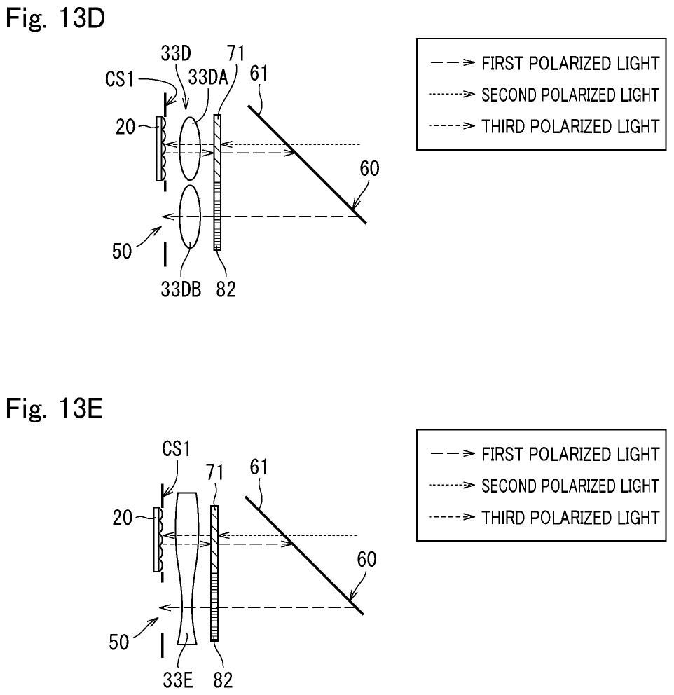

FIGS. 13A to 13E are schematic views for explaining another examples of first lens elements 33A to 33E.

As illustrated in FIG. 13A, the first lens element 33 A may be disposed between the lens array element 20 and the first retardation plate 71 and between the opening 50 and the second polarizer 82.

As illustrated in FIG. 13B, the first lens element 33B is disposed between the lens array element 20 and the first retardation plate 71, but may not be disposed between the opening 50 and the second polarizer 82.

As illustrated in FIG. 13C, the first lens element 33C is disposed between the opening 50 and the second polarizer 82, but may not be disposed between the lens array element 20 and the first retardation plate 71.

As illustrated in FIG. 13D, the first lens element 33D may include two lens elements 33DA and 33 DB. The lens element 33DA is disposed between the lens array element 20 and the first retardation plate 71, but may not be disposed between the opening 50 and the second polarizer 82. The lens element 33 DB is disposed between the opening 50 and the second polarizer 82, but may not be disposed between the lens array element 20 and the first retardation plate 71.

As illustrated in FIG. 13E, the first lens element 33E may be a free-form surface lens disposed between the lens array element 20 and the first retardation plate 71 and between the opening 50 and the second polarizer 82.

Even in the examples as illustrated in FIGS. 13A to 13E, the effects of the optical system 1 according to the first embodiment and the optical system 1B according to the second embodiment can be produced. Further, by devising the shape, number, disposing, and the like of the lens element 33, further downsizing, improvement of optical performance, and uniformity of luminance can be achieved in the optical system 1B.

In the examples illustrated in FIGS. 13A to 13E, another examples of the first lens elements 33A to 33E have been described. However, the shape, number, and disposing of the second lens element 34 or the third lens element 35 may be changed into any configuration similar to the first lens element 33.

### Third Embodiment

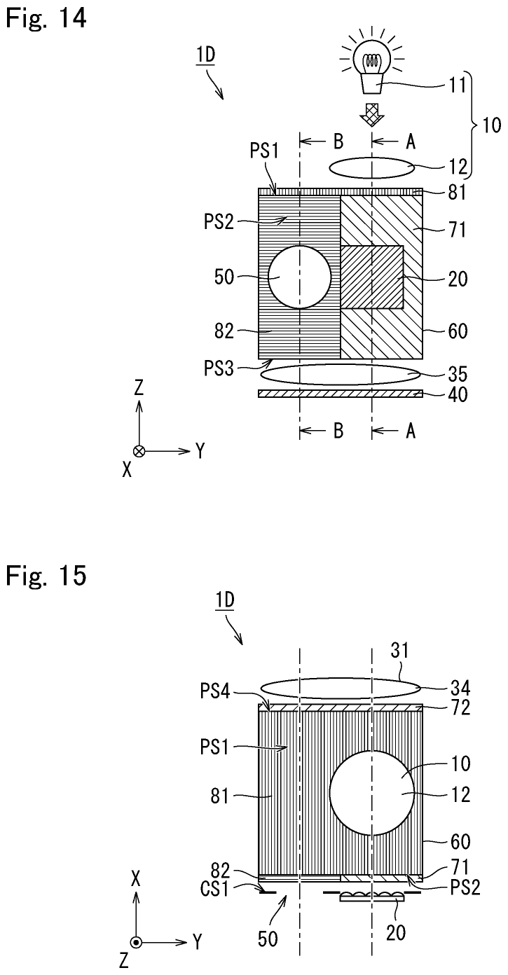

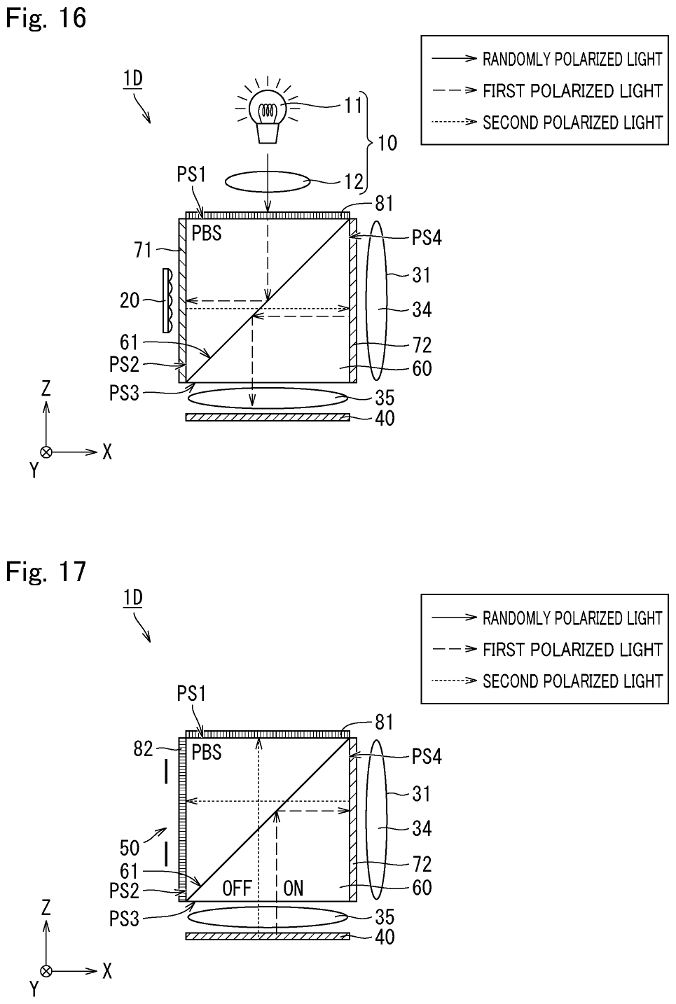

An optical system 1D according to a third embodiment will be described with reference to FIGS. 14 to 17. FIG. 14 is a schematic side view of the optical system 1D in the third embodiment. FIG. 15 is a schematic planar view of the optical system 1D in the third embodiment. FIG. 16 is a schematic cross-sectional view of the optical system 1D illustrated in FIG. 14 taken along line A-A. FIG. 17 is a schematic cross-sectional view of the optical system 1D illustrated in FIG. 14 taken along line B-B. In FIGS. 16 and 17, an optical path and a polarization state of light are indicated by arrows.

In the optical system 1D according to the third embodiment, a cube-shaped polarization beam splitter (PBS) 60 is used. A first lens element 33 is not disposed, but a second lens element 34 and a third lens element 35 are disposed. A reflecting surface 31 is provided on the second lens element 34, but a reflector element 32 is not disposed thereon. The points of the configuration other than the above-described points and points described below are common between the optical system 1D according to the third embodiment and the optical system 1 according to the first embodiment.

The configuration of the optical system 1D will be described.

As illustrated in FIGS. 14 to 17, in the optical system 1D, the polarization beam splitter (PBS) 60 has a cube shape. For example, the polarization beam splitter 60 includes a first surface PS1 to a fourth surface PS4 in a cross section including a light source 10, a lens array element 20, and an image display element 40. The first surface PS1 faces the third surface PS3, and the second surface PS2 faces the fourth surface PS4. Further, the first surface PS1 and the third surface PS3 are orthogonal to the second surface PS2 and the fourth surface PS4. In the polarization beam splitter 60, a split surface 61 is disposed along a direction intersecting the first surface PS1 to the fourth surface PS4.

In the optical system 1D, the light source 10 and a first polarizer 81 are disposed on a first surface PS1 side of the polarization beam splitter 60. The lens array element 20, an opening 50, a first retardation plate 71, and a second polarizer 82 are disposed on a second surface PS2 side. The third lens element 35 and the image display element 40 are disposed on a third surface PS3 side. The second lens element 34 and a second retardation plate 72 are disposed on a fourth surface PS4 side.

The first polarizer 81 is disposed between the first surface PS1 of the polarization beam splitter 60 and the light source 10. The first polarizer 81 is disposed in close contact with the first surface PS1 of the polarization beam splitter 60.

The first retardation plate 71 is disposed between the second surface PS2 of the polarization beam splitter 60 and the lens array element 20, but is not disposed between the second surface PS2 and the opening 50. The second polarizer 82 is disposed between the second surface PS2 and the opening 50, but is not disposed between the second surface PS2 and the lens array element 20. The first retardation plate 71 and the second polarizer 82 are disposed in close contact with the second surface PS2 of the polarization beam splitter 60.

The third lens element 35 is disposed between the third surface PS3 of the polarization beam splitter 60 and the image display element 40.

The second retardation plate 72 is disposed between the fourth surface PS4 of the polarization beam splitter 60 and the second lens element 34. The second retardation plate 72 is disposed in close contact with the fourth surface PS4 of the polarization beam splitter 60.

The reflecting surface 31 is provided on the second lens element 34, and the second lens element 34 also functions as a reflector element.

The optical path of the optical system 1D and the polarization state of light will be described below.

As illustrated in FIG. 16, the light emitted from the light source 10 enters the first surface PS1 of the polarization beam splitter 60 through the first polarizer 81. The light emitted from the light source 10 is random light. This light passes through the first polarizer 81, and thus first polarized light is extracted. As a result, the light in the first polarization state enters the polarization beam splitter 60 through the first surface PS1.

The light in the first polarization state having entered the first surface PS1 is reflected from the split surface 61 and emitted from the second surface PS2. The light emitted from the second surface PS2 enters the lens array element 20 through the first retardation plate 71. At the lens array element 20, light is reflected. The light reflected at the lens array element 20 passes through the first retardation plate 71 again, and enters the polarization beam splitter 60 from the second surface PS2. At this time, the light in the first polarization state passes through the first retardation plate 71 twice to be brought into the second polarization state. Therefore, the light to enter from the second surface PS2 is in the second polarization state.

The light in the second polarization state having entered the second surface PS2 passes through the split surface 61 and is emitted from the fourth surface PS4. The light emitted from the fourth surface PS4 enters the second lens element 34 through the second retardation plate 72. The reflecting surface 31 is provided on the second lens element 34. Therefore, the light having entered the second lens element 34 is condensed and reflected from the reflecting surface 31. The light reflected from the reflecting surface 31 passes through the second retardation plate 72 again, and enters the polarization beam splitter 60 through the fourth surface PS4. At this time, the light in the second polarization state passes through the second retardation plate 72 twice to be brought into the first polarization state. Therefore, the light to enter the fourth surface PS4 is in the first polarization state.

The light in the first polarization state having entered the fourth surface PS4 is reflected from the split surface 61 and emitted from the third surface PS3. The light emitted from the third surface PS3 enters the image display element 40 through the third lens element 35.

As illustrated in FIG. 17, incident light is converted into image light and the image light is reflected at the image display element 40. ON light to be projected as an image and OFF light not projected as an image are output from the image display element 40. The ON light in the first polarization state is brought into the second polarization state, and the OFF light in the first polarization state is maintained at the image display element 40.

The light emitted from the image display element 40 enters the polarization beam splitter 60 from the third surface PS3 through the third lens element 35. The light having entered from the third surface PS3 enters the split surface 61. Since the ON light is in the second polarization state, the ON light is reflected from the split surface 61 and emitted from the fourth surface PS4. Since the OFF light is in the first polarization state, the OFF light is transmitted through the split surface 61 and is emitted from the first surface PS1.

The light emitted from the fourth surface PS4 enters the second lens element 34 through the second retardation plate 72. The light having entered the second lens element 34 is reflected from the reflecting surface 31, and enters the polarization beam splitter 60 from the fourth surface PS4 through the second retardation plate 72. At this time, the light in the first polarization state passes through the second retardation plate 72 twice to be brought into the second polarization state. Therefore, the light to enter from the fourth surface PS4 is in the second polarization state.

The light in the second polarization state having entered from the fourth surface PS4 passes through the split surface 61 and is emitted from the second surface PS2. The light emitted from the second surface PS2 passes through the second polarizer 82, and second polarized light is extracted. Thereafter, the second polarized light is emitted from the opening 50.

As described above, in the optical system 1D, the light source 10, the lens array element 20, and the like are disposed around the cube-shaped polarization beam splitter 60, thereby reducing the disposing space of the optical components. As a result, downsizing of the optical system 1D can be achieved.

In addition, by providing the reflecting surface 31 on the second lens element 34, light can be reflected without separately providing a reflector element. As a result, the space for disposing a reflector element can be omitted, and thus the optical system 1D can be further downsized.

### Fourth Embodiment

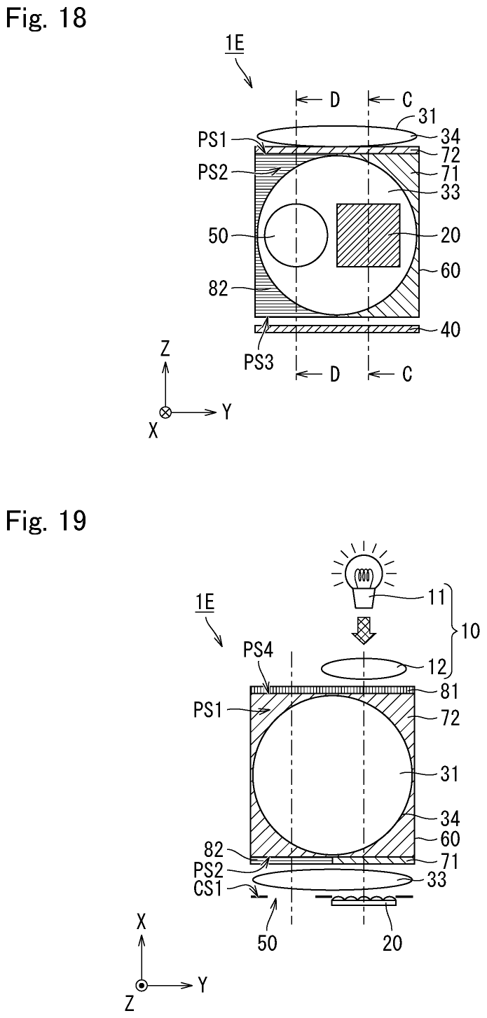

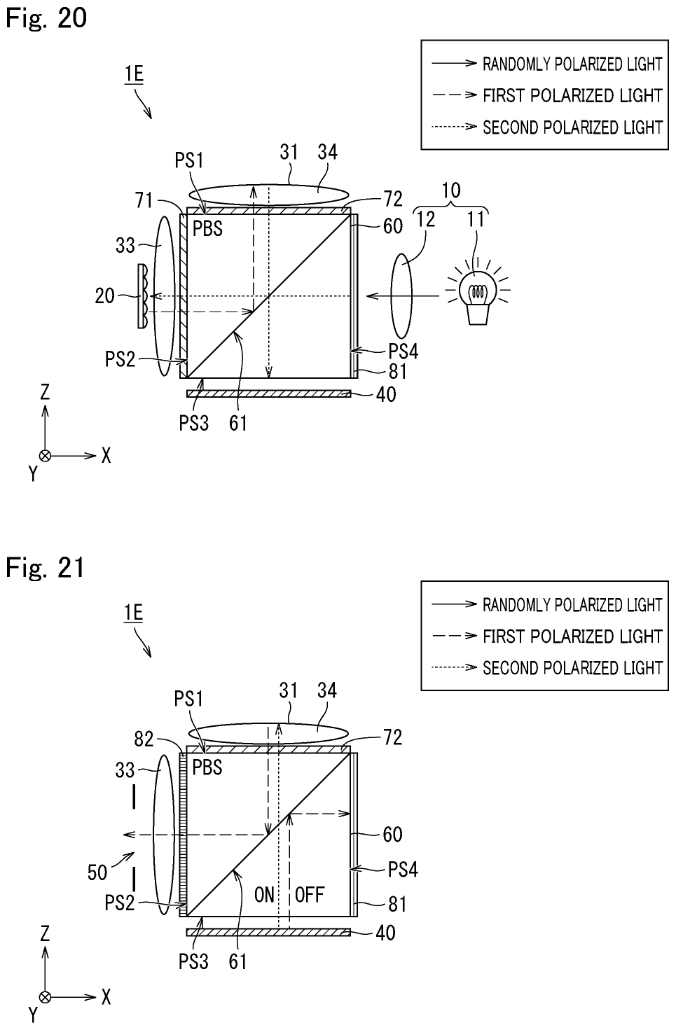

An optical system 1E according to a fourth embodiment will be described with reference to FIGS. 18 to 21. FIG. 18 is a schematic side view of the optical system 1E in the fourth embodiment. FIG. 19 is a schematic planar view of the optical system 1E in the fourth embodiment. FIG. 20 is a schematic cross-sectional view of the optical system 1E illustrated in FIG. 18 taken along line C-C. FIG. 21 is a schematic cross-sectional view of the optical system 1E illustrated in FIG. 18 taken along line D-D. In FIGS. 20 and 21, an optical path and a polarization state of light are indicated by arrows.

In the optical system 1E according to the fourth embodiment, a cube-shaped polarization beam splitter (PBS) 60 is used. A first lens element 33 and a second lens element 34 are disposed, but a third lens element 35 is not disposed. A reflecting surface 31 is provided on the second lens element 34, but a reflector element 32 is not disposed thereon. The points of the configuration other than the above-described points and points described below are common between the optical system 1E according to the fourth embodiment and the optical system 1B according to the second embodiment.

The configuration of the optical system 1E will be described.

As illustrated in FIGS. 18 to 21, in the optical system 1E, the polarization beam splitter (PBS) 60 has a cube shape. Since the polarization beam splitter 60 according to the fourth embodiment is similar to the polarization beam splitter 60 according to the third embodiment, the description thereof will be omitted.

In the optical system 1D, the second lens element 34 and a second retardation plate 72 are disposed on a first surface PS1 side of the polarization beam splitter 60. A lens array element 20, a first lens element 33, an opening 50, a first retardation plate 71, and a second polarizer 82 are disposed on a second surface PS2 side. An image display element 40 is disposed on a third surface PS3 side. A light source 10 and a first polarizer 81 are disposed on a fourth surface PS4 side.

The first polarizer 81 is disposed between the fourth surface PS4 of the polarization beam splitter 60 and the light source 10. The first polarizer 81 is disposed in close contact with the fourth surface PS4 of the polarization beam splitter 60.

The first retardation plate 71 is disposed between the second surface PS2 of the polarization beam splitter 60 and the lens array element 20, but is not disposed between the second surface PS2 and the opening 50. The second polarizer 82 is disposed between the second surface PS2 and the opening 50, but is not disposed between the second surface PS2 and the lens array element 20. The first retardation plate 71 and the second polarizer 82 are disposed in close contact with the second surface PS2 of the polarization beam splitter 60.

The first lens element 33 is disposed between the lens array element 20 and the first retardation plate 71 and between the opening 50 and the second polarizer 82.

The second retardation plate 72 is disposed between the first surface PS1 of the polarization beam splitter 60 and the second lens element 34. The second retardation plate 72 is disposed in close contact with the first surface PS1 of the polarization beam splitter 60.

The reflecting surface 31 is provided on the second lens element 34, and the second lens element 34 also functions as a reflector element.

An optical path of the optical system 1E and a polarization state of light will be described below.

As illustrated in FIG. 20, light emitted from the light source 10 enters the fourth surface PS4 of the polarization beam splitter 60 through the first polarizer 81. The light emitted from the light source 10 is random light. This light passes through the first polarizer 81, and thus second polarized light is extracted. As a result, the light in the second polarization state enters the polarization beam splitter 60 through the fourth surface PS4.

The light in the second polarization state having entered the fourth surface PS4 is transmitted through a split surface 61 and is emitted from the second surface PS2. The light emitted from the second surface PS2 enters the lens array element 20 through the first retardation plate 71 and the first lens element 33. At the lens array element 20, light is reflected. The light reflected at the lens array element 20 passes through the first retardation plate 71 and the first lens element 33 again, and enters the polarization beam splitter 60 from the second surface PS2. At this time, the light in the second polarization state passes through the first retardation plate 71 twice to be brought into the first polarization state. Therefore, the light to enter the second surface PS2 is in the first polarization state.

The light in the first polarization state having entered the second surface PS2 is reflected from the split surface 61 and emitted from the first surface PS1. The light emitted from the first surface PS1 enters the second lens element 34 through the second retardation plate 72. The reflecting surface 31 is provided on the second lens element 34. Therefore, the light having entered the second lens element 34 is condensed and reflected from the reflecting surface 31. The light reflected from the reflecting surface 31 passes through the second retardation plate 72 again, and enters the polarization beam splitter 60 from the first surface PS1. At this time, the light in the first polarization state passes through the second retardation plate 72 twice to be brought into the second polarization state. Therefore, the light to enter the first surface PS1 is in the second polarization state.

The light in the second polarization state having entered the first surface PS1 is transmitted through the split surface 61 and is emitted from the third surface PS3. The light emitted from the third surface PS3 enters the image display element 40.

As illustrated in FIG. 21, the incident light is converted into image light, the image light is reflected at the image display element 40. ON light to be projected as an image and OFF light not projected as an image are output from the image display element 40. At the image display element 40, ON light is maintained in the second polarization state, and OFF light in the second polarization state is brought into the first polarization state.

The light emitted from the image display element 40 enters the polarization beam splitter 60 from the third surface PS3. The light having entered from the third surface PS3 enters the split surface 61. Since the ON light is in the second polarization state, the ON light is transmitted through the split surface 61 and is emitted from the first surface PS1. Since the OFF light is in the first polarization state, the OFF light is reflected from the split surface 61 and emitted from the fourth surface PS4.

The light emitted from the first surface PS1 enters the second lens element 34 through the second retardation plate 72. The light having entered the second lens element 34 is reflected from the reflecting surface 31, and enters the polarization beam splitter 60 from the first surface PS1 through the second retardation plate 72. At this time, the light in the second polarization state passes through the second retardation plate 72 twice to be brought into the first polarization state. Therefore, the light to enter from the first surface PS1 is in the first polarization state.

The light in the first polarization state having entered the first surface PS1 is reflected from the split surface 61 and emitted from the second surface PS2. The light emitted from the second surface PS2 passes through the second polarizer 82 and the first lens element 33. Then, first polarized light is extracted, and after unnecessary light is reduced, the first polarized light enters the opening 50.

As described above, in the optical system 1E, the light source 10, the lens array element 20, and the like are disposed around the cube-shaped polarization beam splitter 60, thereby reducing the disposing space of the optical components. As a result, the downsizing of the optical system 1E can be achieved.

### Fifth Embodiment

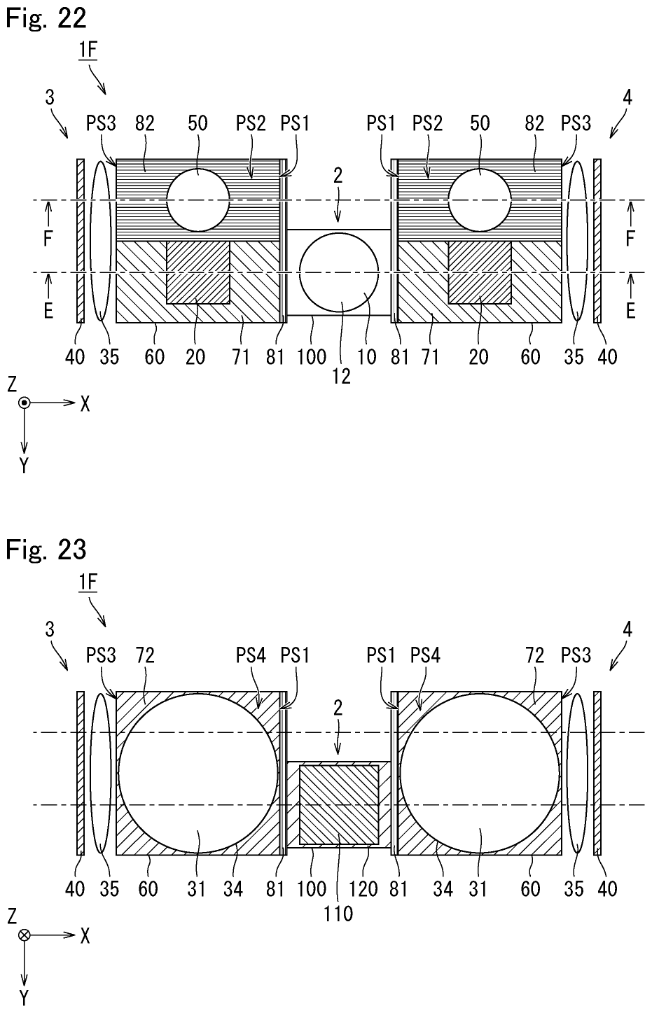

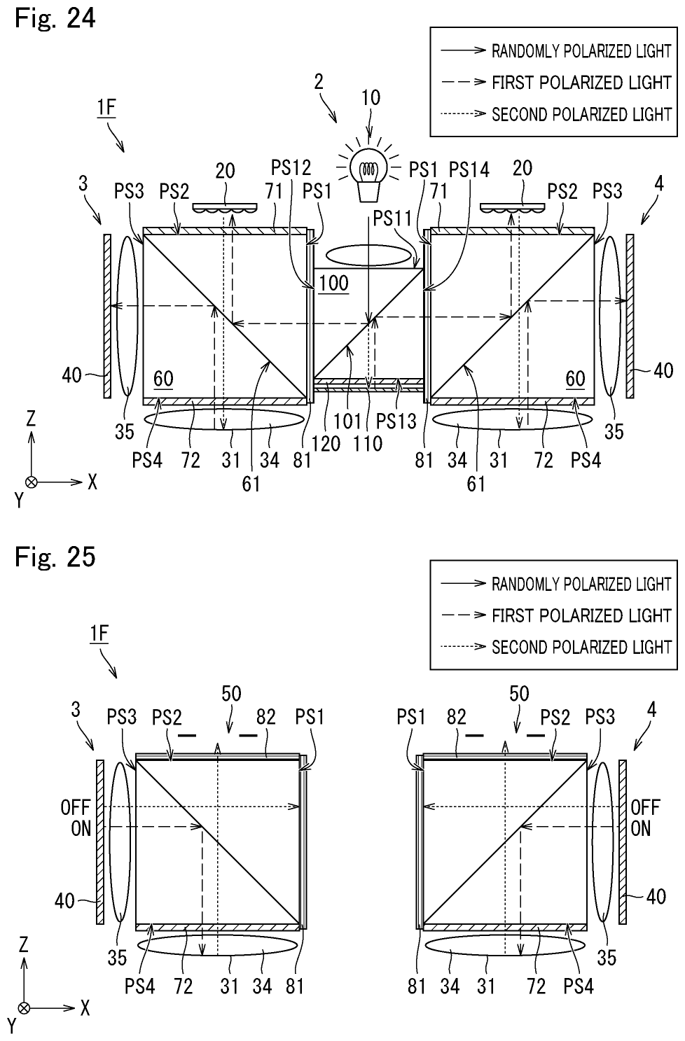

An optical system 1F according to a fifth embodiment will be described with reference to FIGS. 22 to 25. FIG. 22 is a schematic view of the optical system 1F when viewed from a light source in the fifth embodiment. FIG. 23 is a schematic view of the optical system 1F when viewed from a reflecting surface of a first optical system 2 in the fifth embodiment. FIG. 24 is a schematic cross-sectional view of the optical system 1F illustrated in FIG. 22 taken along line E-E. FIG. 25 is a schematic cross-sectional view of the optical system 1F illustrated in FIG. 22 taken along line F-F. In FIGS. 24 and 25, an optical path and a polarization state of light are indicated by arrows.

The optical system 1F according to the fifth embodiment includes a first optical system 2, a second optical system 3, and a third optical system 4. The first optical system 2 is disposed between the second optical system 3 and the third optical system 4, and emits light to the second optical system 3 and the third optical system 4. The second optical system 3 and the third optical system 4 receive the light from the first optical system 2, convert the light into image light, and emit the image light.

The configuration of the optical system 1F will be described.

As illustrated in FIGS. 22 to 25, the first optical system 2 includes a light source 10, a polarization beam splitter 100, a reflector element 110, and a retardation plate 120.

The light source 10 is similar to the light source 10 according to the first embodiment. When viewed from the direction (X direction) where the first optical system 2 to the third optical system 4 are disposed, the light source 10 is disposed on the same side as the side where the lens array element 20 and the opening 50 of each of the second optical system 3 and the third optical system 4 are disposed.

The polarization beam splitter 100 splits the randomly polarized light into first light in the first polarization state and second light in the second polarization state, guides the first light in a first direction, and guides the second light in a second direction different from the first direction. The polarization beam splitter 100 includes a split surface 101 where the randomly polarized light is split into the first light and the second light.

At the split surface 101, first polarized light is reflected and second polarized light is transmitted. At the split surface 101, the randomly polarized light is split into the first light in the first polarization state and the second light in the second polarization state. The first light is obtained by reflecting the first polarized light out of the randomly polarized light. The second light is obtained by transmitting the second polarized light out of the randomly polarized light. The split surface 101 is disposed inside the polarization beam splitter 100.

The polarization beam splitter 100 has, for example, a cube shape. For example, the polarization beam splitter 100 includes a first surface PS11 to a fourth surface PS14 in a cross section including the light source 10, the second optical system 3, and the third optical system 4. The first surface PS11 faces the third surface PS13, and the second surface PS12 faces the fourth surface PS14. Further, the first surface PS11 and the third surface PS13 are orthogonal to the second surface PS12 and the fourth surface PS14.

The light source 10 is disposed on a first surface PS11 side of the polarization beam splitter 100. The second optical system 3 is disposed on a second surface PS12 side. The reflector element 110 and the retardation plate 120 are disposed on a third surface PS13 side. The third optical system 4 is disposed on a fourth surface PS14 side.

The first surface PS11 of the polarization beam splitter 100 is an incident surface where the randomly polarized light from the light source 10 enters. The second surface PS12 is an outgoing surface where the first light is emitted. The fourth surface PS14 is an outgoing surface where the second light is emitted.

The reflector element 110 is an optical element where light is reflected. The reflector element 110 includes a reflecting surface where light is reflected. The reflector element 110 is disposed on an optical path of the second light transmitted through the split surface 101 on the third surface PS13 side of the polarization beam splitter 100. Further, the reflector element 110 is disposed away from the third surface PS13 of the polarization beam splitter 100 and is disposed in close contact with the retardation plate 120. For example, the reflector element 110 is disposed within a range between 0.05mm and 2.0 mm, inclusive, from retardation plate 120.

The second light split at the split surface 101 is reflected from the reflecting surface of the reflector element 110. Specifically, at the reflecting surface, the second light is reflected, and is guided to the split surface 101 again.

The reflecting surface of the reflector element 110 is provided on a side facing the third surface PS13 of the polarization beam splitter 100.

For example, as the reflector element 110, a mirror or a lens having a curved surface can be used. Alternatively, the reflecting surface of the reflector element 110 may be a flat surface.

At the retardation plate 120, the polarization state of polarized light is changed. The retardation plate 120 is disposed between the polarization beam splitter 100 and the reflector element 110.

The retardation plate 120 is similar to the retardation plate 71 according to the first embodiment.

The second optical system 3 and the third optical system 4 are similar to the optical system 1D according to the third embodiment except that the light source 10 is not provided. The second optical system 3 and the third optical system 4 are symmetrically disposed with the first optical system 2 being interposed therebetween. In the present embodiment, the second optical system 3 is disposed in the first direction, and the third optical system 4 is disposed in the second direction.

The second optical system 3 and the third optical system 4 are disposed in close contact with the first optical system 2. Specifically, the first surface PS1 of the polarization beam splitter 60 of the second optical system 3 is disposed in close contact with the second surface PS12 of the polarization beam splitter 100 of the first optical system 2 via the first polarizer 81. The first surface PS1 of the polarization beam splitter 60 of the third optical system 4 is disposed in close contact with the fourth surface PS14 of the polarization beam splitter 100 of the first optical system 2 via the first polarizer 81.

The optical path of the optical system 1F and the polarization state of light will be described below.

As illustrated in FIG. 24, in the first optical system 2, the light emitted from the light source 10 enters the first surface PS11 of the polarization beam splitter 100. The light having entered the first surface PS11 enters the split surface 101.

The light emitted from the light source 10 is randomly polarized light. Therefore, at the split surface 101, the randomly polarized light is split into the first light in the first polarization state and the second light in the second polarization state. The first light is obtained by reflecting the first polarized light out of the randomly polarized light. The second light is obtained by transmitting the second polarized light out of the randomly polarized light.

The first light reflected from the split surface 101 enters the second optical system 3 located in the first direction. Specifically, the first light is emitted from the second surface PS12 of the polarization beam splitter 100 of the first optical system 2, and enters the first surface PS1 of the polarization beam splitter 60 in the second optical system 3. The second optical system 3 receives the first light, converts the first light into image light, and projects the image light. Note that the optical path of the second optical system 3 and the light polarization state of light are similar to those in the third embodiment, and thus description thereof is omitted.

The second light transmitted through the split surface 101 is emitted from the third surface PS13 of the polarization beam splitter 100, and enters the reflector element 110 through the retardation plate 120. The second light having entered the reflector element 110 is reflected from the reflecting surface, and enters the third surface PS13 of the polarization beam splitter 100 again through the retardation plate 120. By passing through the retardation plate 120 twice, the second light in the second polarization state obtains retardation of λ/2 and is brought into the first polarization state.

The second light in the first polarization state having entered the third surface PS13 enters the split surface 101. At the split surface 101, the second light is reflected. The second light reflected from the split surface 101 enters the third optical system 4 located in the second direction. Specifically, the second light is emitted from the fourth surface PS14 of the polarization beam splitter 100 of the first optical system 2 and enters the first surface PS1 of the polarization beam splitter 60 of the third optical system 4. The third optical system 4 receives the second light, converts the second light into image light, and projects the image light. Note that the optical path of the third optical system 4 and the light polarization state are similar to those of the third embodiment, and thus description thereof is omitted.

As described above, the optical system 1F includes the first optical system 2 that emits the first light and the second light, the second optical system 3 where the first light emitted from the first optical system 2 enters, and the third optical system 4 where the second light emitted from the first optical system 2 enters. The first optical system 2 includes the light source 10, the polarization beam splitter 100, the reflector element 110, and the retardation plate 120. The light source 10 collimates and emits the randomly polarized light. The polarization beam splitter 100 includes the split surface where the randomly polarized light is split into the first light in the first polarization state and the second light in the second polarization state. The first light is obtained by reflecting the first polarized light out of the randomly polarized light. The second light is obtained by transmitting the second polarized light out of the randomly polarized light. The reflector element 110 includes the reflecting surface where the second light split from the split surface 101 is reflected. The retardation plate 120 is disposed between the polarization beam splitter 100 and the reflector element 110. At the split surface 101, the first light is guided to the second optical system 3. At the retardation plate 120, the second polarization state of the second light is changed to the first polarization state. At the split surface 101, the second light brought into the first polarization state is reflected and guided to the third optical system 4.

With such a configuration, downsizing of the optical system 1F can be achieved while the light use efficiency of the light source 10 is being improved. Specifically, the first optical system 2 splits the randomly polarized light from the light source 10 into the first light in the first polarization state and the second light in the second polarization state at the split surface 101 of the polarization beam splitter 100. The first light is guided at the split surface 101 and enters the second optical system 3 located in the first direction. The second light in the second polarization state is brought into the first polarization state by using the reflector element 110 and the retardation plate 120. The second light brought into the first polarization state is guided at the split surface 101 and enters the third optical system 4 located in the second direction.

In general, two light sources are used in the optical system that outputs two lights whose polarization states are aligned. Therefore, the downsizing of the optical system may be difficult. The optical system 1F according to the present embodiment splits the randomly polarized light from one light source 10 into the first light and the second light, and outputs the first light and the second light with their polarization states being aligned. Since the light source 10 can be shared for outputting the first light and outputting the second light, the downsizing of the optical system 1F can be achieved while the light use efficiency of the light source 10 is being improved. Further, the manufacturing cost of the optical system 1F can be reduced.

In the optical system 1F, the polarization state of the second light is changed to be the same as that of the first light using the reflector element 110 and the retardation plate 120. As a result, the light use efficiency of the light source 10 is improved. Note that, in general, in most of optical systems that split random light using the polarization beam splitter, light entering a projection optical system is extracted and other light is discarded. In the optical system 1F according to the present embodiment, the light use efficiency is improved by changing the polarization state and utilizing the second light without discarding this light.

In the present embodiment, an example has been described in which the second optical system 3 and the third optical system 4 are the optical system 1D according to the third embodiment, but the present disclosure is not limited thereto.

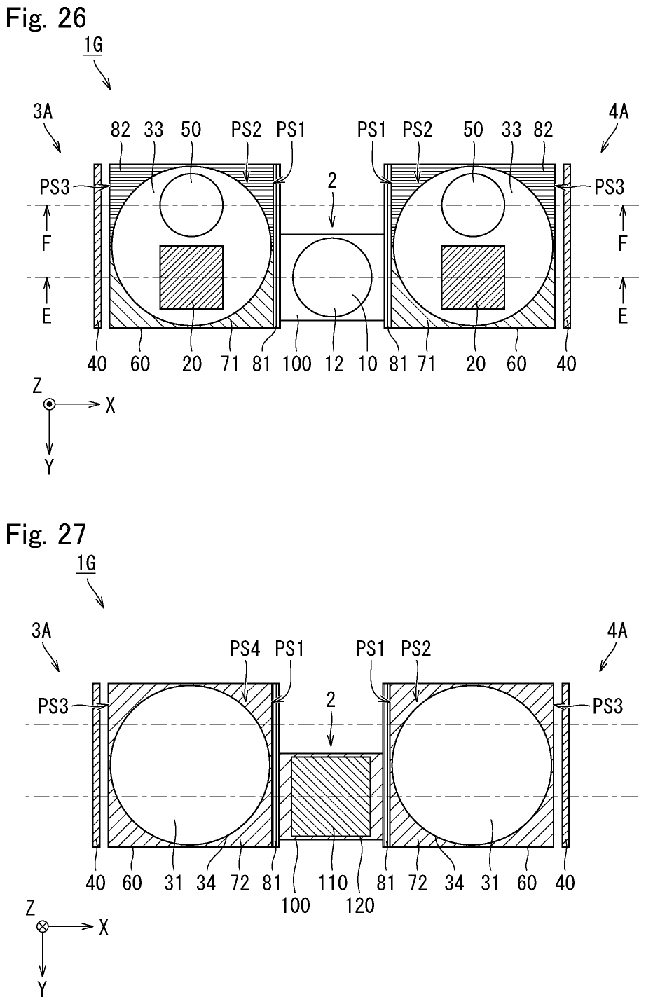

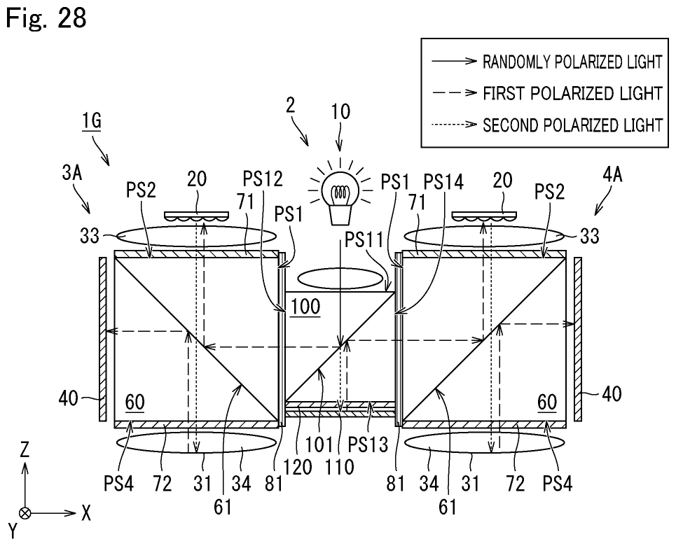

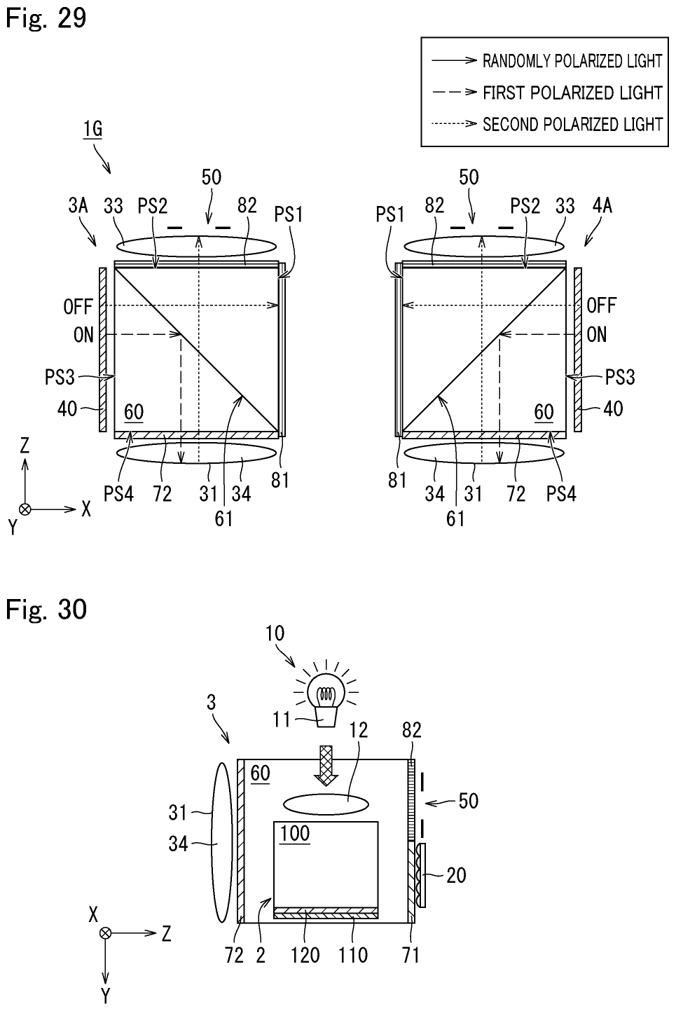

FIG. 26 is a schematic view of an optical system 1G when viewed from the light source side in a third modification. FIG. 27 is a schematic view of the optical system 1G when viewed from the reflecting source side in the third modification. FIG. 28 is a schematic cross-sectional view of the optical system 1G illustrated in FIG. 26 taken along line G-G. FIG. 29 is a schematic cross-sectional view of the optical system 1G illustrated in FIG. 26 taken along line H-H. In FIGS. 28 and 29, an optical path and a light polarization state are indicated by arrows.

As illustrated in FIGS. 26 to 29, in the optical system 1G, a second optical system 3A and a third optical system 4A may be the optical system 1E according to the fourth embodiment.

In the present embodiment, an example has been described in which in the first optical system 2, the light source 10 is disposed on the same side as the side where the lens array element 20 and the opening 50 of each of the second optical system 3 and the third optical system 4 are disposed when viewed from the direction (X direction) where the first optical system 2 to the third optical system 4 are disposed. However, the present disclosure is not limited to this.

FIGS. 30 to 32 are schematic views for explaining another example of the disposing of the light source 10 in the fifth embodiment.

As illustrated in FIG. 30, the light source 10 may be disposed on the opening 50 side in the plane including the opening 50 and the lens array element 20. When viewed from the direction (X direction) where the first optical system 2 to the third optical system 4 are disposed, the light source 10 may be disposed in a direction (Y direction) parallel to the direction where the lens array element 20 and the opening 50 are disposed, and may be disposed closer to the opening 50 than the lens array element 20.

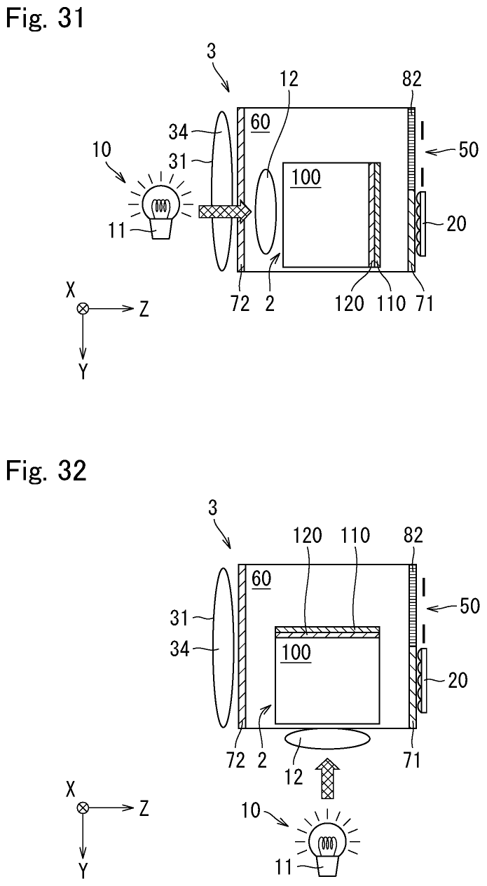

As illustrated in FIG. 31, the light source 10 may be disposed on a side facing the opening 50 and the lens array element 20. When viewed from the direction (X direction) where the first optical system 2 to the third optical system 4 are disposed, the light source 10 may be disposed on the reflecting surface 31 side opposite from the opening 50 and the lens array element 20.

As illustrated in FIG. 32, the light source 10 may be disposed on the lens array element 20 side in the plane including the opening 50 and the lens array element 20. When viewed from the direction (X direction) where the first optical system 2 to the third optical system 4 are disposed, the light source 10 may be disposed in the direction (Y direction) parallel to the direction where the lens array element 20 and the opening 50 are disposed, and may be disposed closer to the lens array element 20 than the opening 50.

In this manner, the flexibility for disposing the light source 10 can be improved. As a result, the optical system 1G can be further downsized.

In the present embodiment, an example in which the second optical system 3 and the third optical system 4 are disposed in close contact with the first optical system 2 has been described, but the present disclosure is not limited thereto.

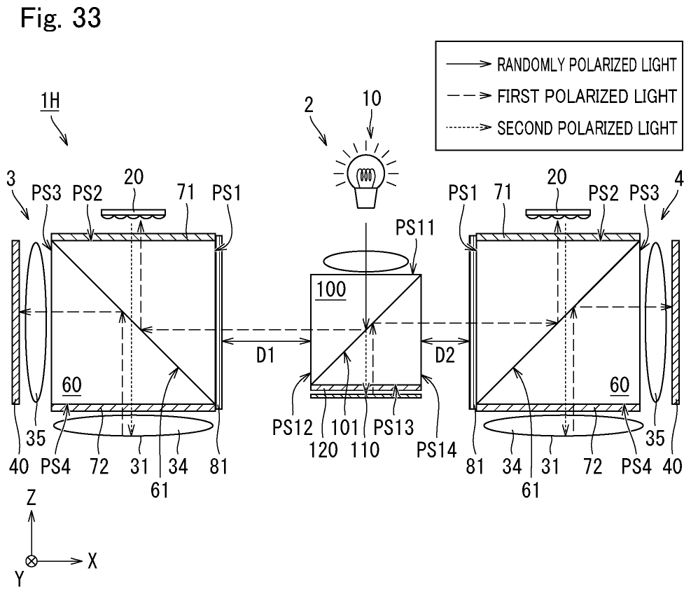

FIG. 33 is a schematic cross-sectional view of an optical system 1H according to a fourth modification. As illustrated in FIG. 33, in the optical system 1H, the second optical system 3 may be disposed at a position away from the first optical system 2 by first distance D1. The third optical system 4 may be disposed at a position away from the first optical system 2 by a second distance D2. The points of the configuration other than the above-described points and points described below are common between the optical system 1H according to the fourth modification and the optical system 1F according to the fifth embodiment.

The first distance DI is a distance between the polarization beam splitter 100 of the first optical system 2 and the second projection optical system 3. Specifically, the first distance DI is a distance from the second surface PS12 of the polarization beam splitter 100 of the first optical system 2 to an optical element disposed at a position closest to the second surface PS12 among the optical elements constituting the second projection optical system 3. In the fourth modification, the first distance D1 is a distance from the second surface PS12 of the polarization beam splitter 100 of the first optical system 2 to the first polarizer 81 of the second optical system 3.

The second distance D2 is a distance between the polarization beam splitter 100 of the first optical system 2 and the third optical system 4. Specifically, the second distance D2 is a distance from the fourth surface PS14 of the polarization beam splitter 100 of the first optical system 2 to an optical element disposed at a position closest to the fourth surface PS14 among the optical elements constituting the third optical system 4. In the fourth modification, the second distance D2 is a distance from the fourth surface PS14 of the polarization beam splitter 100 of the first optical system 2 to the first polarizer 81 of the third optical system 4.

The first distance D1 and the second distance D2 are set so that the first light to enter the second optical system 3 and the second light to enter the third optical system 4 have approximately identical luminance distribution. Specifically, the first distance D1 and the second distance D2 are set so that the length of an optical path until the light emitted from the light source 10 enters the second optical system 3 is approximately identical to the length of an optical path until the light emitted from the light source 10 enters the third optical system 4.

Inside the polarization beam splitter 100 of the first optical system 2, the first light is reflected from the split surface 101 and then emitted from the second surface PS12. On the other hand, the second light is transmitted through the split surface 101, and then reflected from the reflecting surface of the reflector element 110. The second light is further reflected from the split surface 101 and emitted from the fourth surface PS14. In such a way, in the polarization beam splitter 100 of the first optical system 2, the optical path of the second light is longer than the optical path of the first light. Therefore, by setting the second distance D2 to be shorter than the first distance D1, the first light to enter the second optical system 3 and the second light to enter the third optical system 4 are able to have approximately the same luminance distribution.

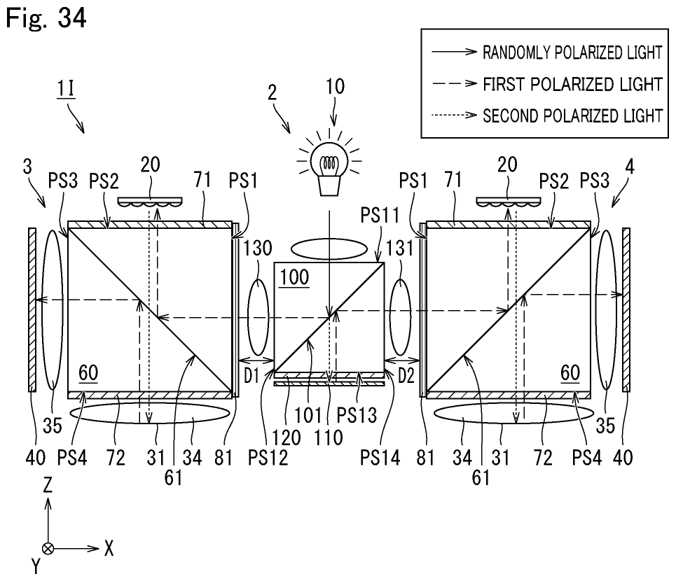

FIG. 34 is a schematic cross-sectional view of an optical system 1I according to a fifth modification. As illustrated in FIG. 34, in the optical system 1I, a fourth lens element 130 may be disposed between the first optical system 2 and the second optical system 3. Further, a fifth lens element 131 may be disposed between the first optical system 2 and the third optical system 4. The points of the configuration other than the above-described points and points described below are common between the optical system 1I according to the fifth modification and the optical system 1H according to the fourth modification.

The fourth lens element 130 is disposed on the optical path of the first light emitted from the polarization beam splitter 100 of the first optical system 2. The fourth lens element 130 is disposed between the polarization beam splitter 100 of the first optical system 2 and the second optical system 3. The fourth lens element 130 allows the first light to be condensed.

The fifth lens element 131 is disposed on the optical path of the second light emitted from the polarization beam splitter 100 of the first optical system 2. The fifth lens element 131 is disposed between the polarization beam splitter 100 of the first optical system 2 and the third optical system 4. The fifth lens element 131 allows the second light to be condensed.

For example, the fourth lens element 130 and the fifth lens element 131 are relay lenses. Different relay lenses are used as the fourth lens element 130 and the fifth lens element 131. For example, the refracting power of the fourth lens element 130 is greater than the refracting power of the fifth lens element 131.

With such a configuration, the first light to enter the second optical system 3 can be condensed by the fourth lens element 130, and the luminance distribution of the first light can be made uniform. The second light to enter the third optical system 4 can be condensed by the fifth lens element 131, and the luminance distribution of the second light can be made uniform.

Further, the first distance D1 between the first optical system 2 and the second optical system 3 can be shortened to be equivalent to the second distance D2 between the first optical system 2 and the third optical system 4 by increasing the refracting power of the fourth lens element 130 to be greater than the refracting power of the fifth lens element 131. As a result, the optical system 1I can be further downsized.

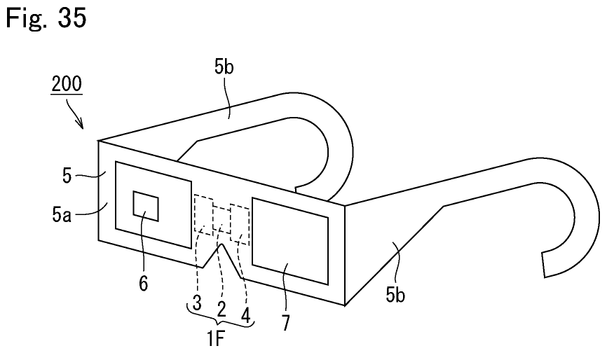

A head mounted display will be described as an example of a projection image display device including the optical system 1F according to the fifth embodiment. FIG. 35 is a schematic view for explaining a head mount display 200 including the optical system 1F according to the fifth embodiment. As illustrated in FIG. 35, the optical system 1F may be applied to the head mount display 200. The head mount display 200 includes the optical system 1F, a casing frame 5, a first display screen 6, and a second display screen 7. The first display screen 6 and the second display screen 7 each include, for example, an optical device or the like that guides the image light from the second optical system 3 and the third optical system 4 to eyes of a user. Further, a light guide plate or the like having a diffractive structure in a transmissive optical material may be used as a configuration for superimposing an image on the outside world.

The casing frame 5 is a spectacle-shaped frame. For example, the casing frame 5 includes a front frame 5a and a support frame 5b extending from both sides of the front frame 5a. In a state where a user wears the head mount display 200, the front frame 5a is placed in front of the eyes of the user, and the support frame 5b is supported by ears of the user.

The optical system 1F is housed inside the center of the front frame 5a. On the front frame 5a, the first display screen 6 and the second display screen 7 are disposed with the optical system 1F being interposed therebetween. In a state where the user wears the head mount display 200, the first display screen 6 and the second display screen 7 are placed in front of the eyes of the user.

An image projected from the second optical system 3 is displayed on the first display screen 6. An image projected from the third optical system 4 is displayed on the second display screen 7.

As described above, the head mount display 200 includes the second optical system 3 and the third optical system 4 with which the optical system 1F projects light. The second optical system 3 projects an image for the right eye of the user. The third optical system 4 projects an image for the left eye of the user.

Note that the head mount display 200 is not limited to an eyeglass type display. For example, the head mount display 200 may be configured to be attached on a head without the support frame.

### Other Embodiments

The above embodiments have been described as the examples of the technique disclosed in this application. However, the technique in the present disclosure is not limited to them, and is applicable to embodiments in which changes, replacements, additions, omissions, etc. are made as appropriate. Therefore, other embodiments will be exemplified below.

In the first to fifth embodiments, the optical systems 1 to 1I including the image display element 40 have been described. However, the image display element 40 may not be indispensable.

In the first to fifth embodiments, the examples have been described in which the lens array element 20 and the opening 50 are optically conjugate to each other in the optical systems 1 to 1I using the lens array element 20. However, the lens array element 20 may be used in an optical system where the lens array element 20 and the opening 50 are not optically conjugate to each other.

In the first to fifth embodiments, the examples have been described in which the first lens element 33 to the third lens element 35, the fourth lens element 130, and the fifth lens element 131 each include one lens. However, the first lens element 33 to the third lens element 35, the fourth lens element 130, and the fifth lens element 131 each may include a plurality of lens elements. The first lens element 33 to the third lens element 35, the fourth lens element 130, and the fifth lens element 131 each may be made of a glass material or a resin material. The use of the glass material improves the reliability, and the use of the resin material can reduce the cost. The first lens element 33 to the third lens element 35 each may be a cemented lens including a plurality of lenses. The first lens element 33 to the third lens element 35 may include a plurality of lenses. The plurality of lenses may include a cemented lens.

In the first to fourth embodiments, the examples in which the light source 10 emits randomly polarized light have been described. However, the light emitted from the light source 10 is not limited to the randomly polarized light. For example, the light source 10 may emit first polarized light or second polarized light.

In the fifth embodiment, the example in which the polarization beam splitter 100 has a cube shape has been described. However, the shape of the polarization beam splitter 100 of the first optical system 2 is not limited to the cube shape. For example, the polarization beam splitter 100 may have a plate shape. In this case, the first distance D1 may be a distance from the center of the split surface 101 to the second optical system 3, and the second distance D2 may be a distance from the center of the split surface 101 to the third optical system 4.

In the fifth embodiment, the example in which the optical system 1F is applied to the head mount display 200 has been described. However, the optical system 1F may be applied to devices other than the head mount display 200. For example, the optical system 1F may be applied to a projection image display device such as a projector that projects images. Similarly, the optical systems 1 to 1E according to the first to fourth embodiments and the optical systems 1G to 1I according to the fifth embodiment may also be applied to projection image display devices such as a head-up display and a projector.

In the first to fifth embodiments, the examples in which the polarization beam splitters 60 and 100 respectively include the split surfaces 61 and 101 have been described. However, the split surfaces 61 and 101 may be provided respectively in optical elements other than the polarization beam splitters 60 and 100. Further, in the optical systems 1 to 1I, the polarization beam splitters 60 and 100 may not be indispensable.

In the first to fifth embodiments, the examples in which the light source light emitted from the light source 10 is randomly polarized light have been described. However, the light source light may be another light source light. For example, the light source light may be linearly polarized light including components of first polarized light and second polarized light, light obtained by combining the first polarized light and the second polarized light, circularly polarized light, elliptically polarized light, or light obtained by combining such light. That is, the light source light may be light including the first polarized light and the second polarized light.

In this specification, the terms “first”, “second”, and the like are only used for description, and should not be understood as explicitly or implying of relative importance or a rank of technical features. The features limited to “first” and “second” are intended to clarify or imply the inclusion of one or more such features.

### Outline of Embodiments

(1) An optical system of the present disclosure includes: a lens array element including a transmission surface and a first reflecting surface, the transmission surface including a lens array, the first reflecting surface facing the transmission surface, the lens array element being configured to reflect, at the first reflecting surface, light received from the transmission surface and emit the light from the transmission surface; an image display element configured to convert the received light into image light and emit the image light; a plurality of optical elements configured to guide the light emitted from the lens array element to the image display element in a first order; and an opening through which the image light converted at the image display element is emitted. The plurality of optical elements guides the image light emitted from the image display element to the opening in a second order reverse to the first order.
(2) In the optical system of (1), the lens array element and the opening may be optically conjugate to each other by the plurality of optical elements.
(3) In the optical system of (2), the plurality of optical elements may include a split surface where light is split. The split surface may be configured to reflect first polarized light and transmit second polarized light. The lens array element may be configured to receive and reflect the light in a first polarization state reflected from the split surface or the light in a second polarization state transmitted through the split surface.
(4) The optical system of (3) may further include at least one retardation plate configured to change a polarization state of the light.
(5) In the optical system of (4), the at least one retardation plate may be a ¼ wave plate
(6) In the optical system of (4) or (5), the plurality of optical elements may include a second reflecting surface from which the light reflected at the lens array element and received via the split surface is reflected. The at least one retardation plate may include a first retardation plate disposed between the lens array element and the split surface, and a second retardation plate disposed between the split surface and the second reflecting surface.
(7) The optical system of (6) may further include a light source that emits light. The split surface may allow light in the first polarization state out of the light emitted from the light source to be reflect and guided to the lens array element through the first retardation plate. The lens array element may allow the light to be reflected and guided to the split surface through the first retardation plate. The first retardation plate may allow the light to pass through in a reciprocating manner, and may allow the polarization state of the light to be changed from the first polarization state to the second polarization state. The split surface may allow the light brought into the second polarization state at the first retardation plate to be transmitted through the split surface and guided to the second reflecting surface through the second retardation plate. The second reflecting surface may allow the light to be reflected and guided to the split surface through the second retardation plate. The second retardation plate may allow the light to pass through in a reciprocating manner, and may allow the polarization state of the light to be changed from the second polarization state to the first polarization state. The split surface may allow the light brought into the first polarization state at the second retardation plate to be reflected and guided to the image display element. The image display element may allow the light to be converted into the image light and allows the image light to be guided to the split surface. The split surface may allow the image light to be reflected and guided to the second reflecting surface through the second retardation plate. The second reflecting surface may allow the image light to be reflected and guided to the split surface through the second retardation plate. The second retardation plate may allow the image light to pass through in a reciprocating manner, and may allow a polarization state of the image light to be changed from the first polarization state to the second polarization state. The split surface may allow the image light brought into the second polarization state at the second retardation plate to be transmitted through the split surface and guided to the opening.
(8) The optical system of (6) may further include a light source that emits light. The split surface may allow light in a second polarization state out of the light emitted from the light source to be transmitted through the split surface and guided to the lens array element through the first retardation plate. The lens array element may allow the light to be reflected and guided to the split surface through the first retardation plate. The first retardation plate may allow the light to pass through in a reciprocating manner, and may allow the polarization state of the light to be changed from the second polarization state to the first polarization state. The split surface may allow the light brought into the first polarization state at the first retardation plate to be reflected and guided to the second reflecting surface through the second retardation plate. The second reflecting surface may allow the light to be reflected and guided to the split surface through the second retardation plate. The second retardation plate may allow the light to pass through in a reciprocating manner, and may allow the polarization state of the light to be changed from the first polarization state to the second polarization state. The split surface may allow the light brought into the second polarization state at the second retardation plate to be transmitted through the split surface and guided to the image display element. The image display element may allow the light to be converted into the image light and may allow the image light to be guided to the split surface. The split surface may allow the image light to be transmitted through the split surface and guided to the second reflecting surface through the second retardation plate. The second reflecting surface may allow the image light to be reflected and guided to the split surface through the second retardation plate. The second retardation plate may allow the image light to pass through in a reciprocating manner, and may allow the polarization state of the image light to be changed from the second polarization state to the first polarization state. The split surface may allow the image light brought into the first polarization state at the second retardation plate to be reflected and guided to the opening.
(9) In the optical system of any one of (3) to (8), the plurality of optical elements may include a polarization beam splitter surrounding the split surface. The polarization beam splitter may include an outgoing surface that allows the light to be emitted via the split surface and allows the image light to be emitted. The lens array element and the opening may be disposed on a conjugate surface provided on an outgoing surface side of the polarization beam splitter.
(10) In the optical system of (2), the plurality of optical elements each may include at least one lens element.
(11) The optical system of (10) may further include a light source that emits light; and a polarization beam splitter including a split surface that allows the light from the light source to be split. The plurality of optical elements each may include a second reflecting surface that allows the light reflected at the lens array element and received via the split surface to be reflected. The image display element may allow the light reflected from the second reflecting surface and received via the split surface to be changed into image light. The lens element may include at least one of a first lens element disposed between the split surface and the lens array element, a second lens element disposed between the split surface and the second reflecting surface, and a third lens element disposed between the split surface and the image display element.
(12) In the optical system of (11), the second reflecting surface may be formed on an optical surface of the second lens element.
(13) In the optical system of (12), the at least one lens element may include the first lens element, the second lens element, and the third lens element.
(14) The optical system of any one of (3) to (6) may further include a light source that emits light; and a first polarizer disposed between the split surface and the light source.
(15) The optical system of any one of (3) to (9) may further include a second polarizer disposed between the split surface and the opening.
(16) An optical system of the present disclosure includes: a first optical system that emits first light and second light; a second optical system that receives the first light emitted from the first optical system; and a third optical system that receives the second light emitted from the first optical system. The first optical system includes a light source that collimates randomly polarized light and emits the randomly polarized light, a polarization beam splitter including a split surface that allows the randomly polarized light to be split into first light in a first polarization state and second light in a second polarization state, the first light being obtained by reflecting first polarized light out of the randomly polarized light, the second light being obtained by transmitting second polarized light out of the randomly polarized light, a reflector element including a second reflecting surface that allows the second light split at the split surface to be reflected, and at least one retardation plate disposed between the polarization beam splitter and the reflector element. The split surface allows the first light to be guided to the second optical system. The at least one retardation plate allows the second light in the second polarization state to be brought into the first polarization state. The split surface allows the second light brought into the first polarization state to be reflected and guided to the third optical system. The second optical system and the third optical system each include a lens array element that includes a transmission surface including a lens array and a reflecting surface facing the transmission surface, reflects light received from the transmission surface from the reflecting surface, and emits the light from the transmission surface, an image display element that allows the received light to be converted into image light and emitted, a plurality of optical elements that allows the light emitted from the lens array element to be guided to the image display element in a first order, and an opening through which the image light converted at the image display element is emitted. The plurality of optical elements allows the image light emitted from the image display element to be guided to the opening in a second order reverse to the first order.
(17) A projection image display device of the present disclosure includes the optical system of any one of (1) to (16).
(18) A head mount display includes the optical system of (16). The second optical system projects an image for a right eye of a user. The third optical system projects an image for a left eye of the user.

The present disclosure is applicable to, for example, an optical system of a projection image display device, such as a head mount display or a projector, that projects an image.

What is claimed is:

1. An optical system comprising:
a lens array element including a transmission surface and a first reflecting surface, the transmission surface including a lens array, the first reflecting surface facing the transmission surface, the lens array element being configured to reflect, at the first reflecting surface, light received from the transmission surface and emit the light from the transmission surface;
an image display element configured to convert the received light into image light and emit the image light;
a plurality of optical elements configured to guide the light emitted from the lens array element to the image display element in a first order; and
an opening through which the image light converted at the image display element is emitted,
wherein the plurality of optical elements guides the image light emitted from the image display element to the opening in a second order reverse to the first order.

2. The optical system according to claim 1, wherein the lens array element and the opening are optically conjugate to each other by the plurality of optical elements.

3. The optical system according to claim 2, wherein the plurality of optical elements includes a split surface where light is split,
wherein the split surface is configured to reflect first polarized light and transmit second polarized light, and
wherein the lens array element is configured to receive and reflect the light in a first polarization state reflected from the split surface or the light in a second polarization state transmitted through the split surface.

4. The optical system according to claim 3, further comprising at least one retardation plate configured to change a polarization state of the light.

5. The optical system according to claim 4, wherein the at least one retardation plate is a ¼ wave plate.

6. The optical system according to claim 4, wherein the plurality of optical elements includes a second reflecting surface from which the light reflected at the lens array element and received via the split surface is reflected, and
wherein the at least one retardation plate includes
a first retardation plate disposed between the lens array element and the split surface, and
a second retardation plate disposed between the split surface and the second reflecting surface.

7. The optical system according to claim 6, further comprising a light source that emits light,
wherein the split surface allows light in the first polarization state out of the light emitted from the light source to be reflect and guided to the lens array element through the first retardation plate,
wherein the lens array element allows the light to be reflected and guided to the split surface through the first retardation plate,
wherein the first retardation plate allows the light to pass through in a reciprocating manner, and allows the polarization state of the light to be changed from the first polarization state to the second polarization state,
wherein the split surface allows the light brought into the second polarization state at the first retardation plate to be transmitted through the split surface and guided to the second reflecting surface through the second retardation plate,
wherein the second reflecting surface allows the light to be reflected and guided to the split surface through the second retardation plate,
wherein the second retardation plate allows the light to pass through in a reciprocating manner, and allows the polarization state of the light to be changed from the second polarization state to the first polarization state,
wherein the split surface allows the light brought into the first polarization state at the second retardation plate to be reflected and guided to the image display element,
wherein the image display element allows the light to be converted into the image light and allows the image light to be guided to the split surface,
wherein the split surface allows the image light to be reflected and guided to the second reflecting surface through the second retardation plate,
wherein the second reflecting surface allows the image light to be reflected and guided to the split surface through the second retardation plate,
wherein the second retardation plate allows the image light to pass through in a reciprocating manner, and allows a polarization state of the image light to be changed from the first polarization state to the second polarization state, and
wherein the split surface allows the image light brought into the second polarization state at the second retardation plate to be transmitted through the split surface and guided to the opening.

8. The optical system according to claim 6, further comprising a light source that emits light,
wherein the split surface allows light in a second polarization state out of the light emitted from the light source to be transmitted through the split surface and guided to the lens array element through the first retardation plate,
wherein the lens array element allows the light to be reflected and guided to the split surface through the first retardation plate,
wherein the first retardation plate allows the light to pass through in a reciprocating manner, and allows the polarization state of the light to be changed from the second polarization state to the first polarization state,
wherein the split surface allows the light brought into the first polarization state at the first retardation plate to be reflected and guided to the second reflecting surface through the second retardation plate,
wherein the second reflecting surface allows the light to be reflected and guided to the split surface through the second retardation plate,
wherein the second retardation plate allows the light to pass through in a reciprocating manner, and allows the polarization state of the light to be changed from the first polarization state to the second polarization state,
wherein the split surface allows the light brought into the second polarization state at the second retardation plate to be transmitted through the split surface and guided to the image display element,
wherein the image display element allows the light to be converted into the image light and allows the image light to be guided to the split surface,
wherein the split surface allows the image light to be transmitted through the split surface and guided to the second reflecting surface through the second retardation plate,
wherein the second reflecting surface allows the image light to be reflected and guided to the split surface through the second retardation plate,
wherein the second retardation plate allows the image light to pass through in a reciprocating manner, and allows the polarization state of the image light to be changed from the second polarization state to the first polarization state, and
wherein the split surface allows the image light brought into the first polarization state at the second retardation plate to be reflected and guided to the opening.

9. The optical system according to claim 3, wherein the plurality of optical elements includes a polarization beam splitter surrounding the split surface,
wherein the polarization beam splitter includes an outgoing surface that allows the light to be emitted via the split surface and allows the image light to be emitted, and
wherein the lens array element and the opening are disposed on a conjugate surface provided on an outgoing surface side of the polarization beam splitter.

10. The optical system according to claim 2, wherein the plurality of optical elements each includes at least one lens element.

11. The optical system according to claim 10, further comprising:
a light source that emits light; and
a polarization beam splitter including a split surface that allows the light from the light source to be split,
wherein the plurality of optical elements each includes a second reflecting surface that allows the light reflected at the lens array element and received via the split surface to be reflected,
wherein the image display element allows the light reflected from the second reflecting surface and received via the split surface to be changed into image light, and
wherein the lens element includes at least one of
a first lens element disposed between the split surface and the lens array element,
a second lens element disposed between the split surface and the second reflecting surface, and
a third lens element disposed between the split surface and the image display element.

12. The optical system according to claim 11, wherein the second reflecting surface is formed on an optical surface of the second lens element.

13. The optical system according to claim 12, wherein the at least one lens element includes the first lens element, the second lens element, and the third lens element.

14. The optical system according to claim 3, further comprising:
a light source that emits light; and
a first polarizer disposed between the split surface and the light source.

15. The optical system according to claim 3, further comprising a second polarizer disposed between the split surface and the opening.

16. An optical system comprising:
a first optical system that emits first light and second light;
a second optical system that receives the first light emitted from the first optical system; and
a third optical system that receives the second light emitted from the first optical system,
wherein the first optical system includes
a light source that collimates randomly polarized light and emits the randomly polarized light,
a polarization beam splitter including a split surface that allows the randomly polarized light to be split into first light in a first polarization state and second light in a second polarization state, the first light being obtained by reflecting first polarized light out of the randomly polarized light, the second light being obtained by transmitting second polarized light out of the randomly polarized light,
a reflector element including a second reflecting surface that allows the second light split at the split surface to be reflected, and
at least one retardation plate disposed between the polarization beam splitter and the reflector element,
wherein the split surface allows the first light to be guided to the second optical system,
wherein the at least one retardation plate allows the second light in the second polarization state to be brought into the first polarization state,
wherein the split surface allows the second light brought into the first polarization state to be reflected and guided to the third optical system,
wherein the second optical system and the third optical system each include
a lens array element that includes a transmission surface including a lens array and a reflecting surface facing the transmission surface, reflects light received from the transmission surface from the reflecting surface, and emits the light from the transmission surface,
an image display element that allows the received light to be converted into image light and emitted,
a plurality of optical elements that allows the light emitted from the lens array element to be guided to the image display element in a first order, and
an opening through which the image light converted at the image display element is emitted, and
wherein the plurality of optical elements guides the image light emitted from the image display element to the opening in a second order reverse to the first order.

17. A projection image display device comprising the optical system according to claim 1.

18. A head mount display comprising the optical system according to claim 16,
wherein the second optical system projects an image for a right eye of a user, and
wherein the third optical system projects an image for a left eye of the user.
